(19) United States
(12) Patent Application Publication
(10) Pub. No.: US 2013/0089779 A1
(43) Pub. Date: Apr. 11, 2013

(54) ELECTROLYTIC SOLUTION, SECONDARY BATTERY, BATTERY PACK, ELECTRIC VEHICLE, ELECTRIC POWER STORAGE SYSTEM, ELECTRIC POWER TOOL, AND ELECTRONIC DEVICE

(71) Applicants: Masayuki Ihara, Fukushima (JP); Tadahiko Kubota, Kanagawa (JP)

(72) Inventors: Masayuki Ihara, Fukushima (JP); Tadahiko Kubota, Kanagawa (JP)

(73) Assignee: SONY CORPORATION, Tokyo (JP)

(21) Appl. No.: 13/618,868

(22) Filed: Sep. 14, 2012

(30) Foreign Application Priority Data
Oct. 7, 2011 (JP) 2011223185
Jan. 6, 2012 (JP) 2012000958

(51) Int. Cl. H01M 10/0564

(52) U.S. Cl. 429/200; 429/188; 429/199

(57) ABSTRACT

A secondary battery includes: a cathode; an anode; and an electrolytic solution, wherein the electrolytic solution includes a cyano cyclic ester carbonate represented by Formula (1) described below,

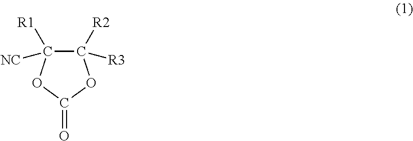

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

### CROSS REFERENCES TO RELATED APPLICATIONS

The present application claims priority to Japanese Patent Application No. 2011-223185 filed on Oct. 7, 2011 and Japanese Patent Application No. 2012-000958 filed on Jan. 6, 2012, the disclosure of which is incorporated herein by reference.

### BACKGROUND

The present technology relates to an electrolytic solution, a secondary battery using the electrolytic solution, a battery pack using the secondary battery, an electric vehicle using the secondary battery, an electric power storage system using the secondary battery, an electric power tool using the secondary battery, and an electronic device using the secondary battery.

In recent years, various electronic devices such as a mobile phone and a personal digital assistant (PDA) have been widely used, and it has been strongly demanded to further reduce the size and the weight of the electronic devices and to achieve their long life. Accordingly, as an electric power source for the electronic devices, a battery, in particular, a small and light-weight secondary battery capable of providing high energy density has been developed. In these days, it has been considered to apply such a secondary battery to various other applications represented by a battery pack attachably and detachably mounted on the electronic devices or the like, an electric vehicle such as an electric automobile, an electric power storage system such as a home electric power server, or an electric power tool such as an electric drill.

As the secondary battery, secondary batteries that obtain a battery capacity by utilizing various charge and discharge principles have been proposed. Specially, a lithium secondary battery using lithium as an electrode reactant is considered promising, since such a lithium secondary battery provides higher energy density than lead batteries, nickel cadmium batteries, and the like. The lithium secondary battery includes a lithium ion secondary battery utilizing insertion and extraction of lithium ions and a lithium metal secondary battery utilizing precipitation and dissolution of lithium metal.

The secondary battery includes a cathode, an anode, and an electrolytic solution. The electrolytic solution contains a solvent and an electrolyte salt. The electrolytic solution functioning as a medium for charge and discharge reaction largely affects performance of the secondary battery. Therefore, various studies have been made on the composition of the electrolytic solution.

Specifically, to improve electrochemical characteristics, studies have been made on using a cyclic ester compound having an electron attractive group such as a halogen group, a cyano group, and a nitro group (for example, see Japanese Unexamined Patent Application Publication Nos. 2005-038722, 2006-019274, and 2009-117382). Examples of the cyclic ester compound include fluoroethylene carbonate, cyanoethylene carbonate, and nitroethylene carbonate.

### SUMMARY

In recent years, high performance and multi-functions of the electronic devices and the like to which the secondary battery is applied are increasingly developed. Therefore, further improvement of the battery characteristics of the secondary battery has been desired.

It is desirable to provide an electrolytic solution capable of providing superior battery characteristics, a secondary battery, a battery pack, an electric vehicle, an electric power storage system, an electric power tool, and an electronic device.

According to an embodiment of the present technology, there is provided an electrolytic solution including a cyano cyclic ester carbonate represented by Formula (1) described below,

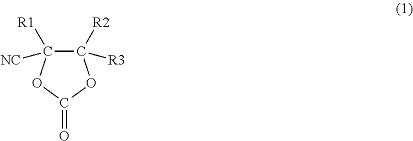

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided a secondary battery including: a cathode; an anode; and an electrolytic solution, wherein the electrolytic solution includes a cyano cyclic ester carbonate represented by Formula (1) described below,

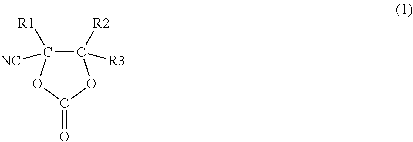

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided a battery pack including: a secondary battery; a control section controlling a usage state of the secondary battery; and a switch section switching the usage state of the secondary battery according to an instruction of the control section, wherein the secondary battery includes a cathode, an anode, and an electrolytic solution, and the electrolytic solution includes a cyano cyclic ester carbonate represented by Formula (1) described below,

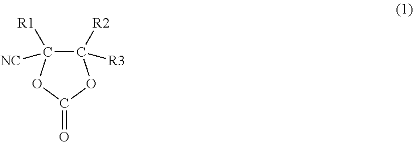

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided an electric vehicle including: a secondary battery; a conversion section converting electric power supplied from the secondary battery to drive power; a drive section operating according to the drive power; and a control section controlling a usage state of the secondary battery, wherein the secondary battery includes a cathode, an anode, and an electrolytic solution, and the electrolytic solution includes a cyano cyclic ester carbonate represented by Formula (1) described below,

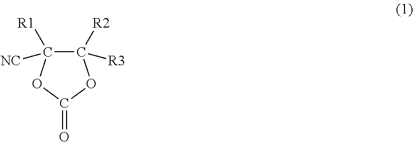

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided an electric power storage system including: a secondary battery; one, or two or more electric devices supplied with electric power from the secondary battery; and a control section controlling the supply of the electric power from the secondary battery to the electric device, wherein the secondary battery includes a cathode, an anode, and an electrolytic solution, and the electrolytic solution includes a cyano cyclic ester carbonate represented by Formula (1) described below,

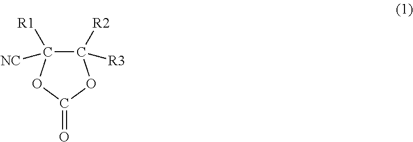

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided an electric power tool including: a secondary battery; and a movable section being supplied with electric power from the secondary battery, wherein the secondary battery includes a cathode, an anode, and an electrolytic solution, and the electrolytic solution includes a cyano cyclic ester carbonate represented by Formula (1) described below,

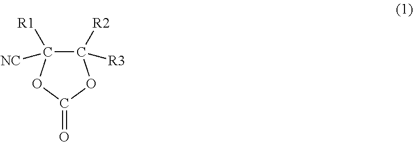

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to an embodiment of the present technology, there is provided an electronic device including a secondary battery as an electric power supply source, wherein the secondary battery includes a cathode, an anode, and an electrolytic solution, and the electrolytic solution includes a cyano cyclic ester carbonate represented by Formula (1) described below,

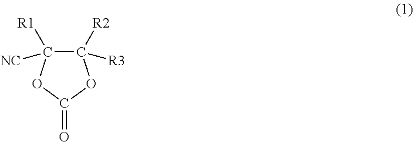

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

According to the electrolytic solution and the secondary battery according to the embodiments of the present technology, since the electrolytic solution contains the cyano cyclic ester carbonate represented by Formula (1), superior battery characteristics are obtainable. Further, according to the battery pack, the electric vehicle, the electric power storage system, the electric power tool, and the electronic device, each using the secondary battery according to the embodiment of the present technology, similar effects are obtainable.

Additional features and advantages are described herein, and will be apparent from the following Detailed Description and the figures.

### BRIEF DESCRIPTION OF THE FIGURES

FIG. 1 is a cross-sectional view illustrating a configuration of a secondary battery (cylindrical type) including an electrolytic solution according to an embodiment of the present technology.

FIG. 2 is a cross-sectional view illustrating an enlarged part of a spirally wound electrode body illustrated in FIG. 1.

FIG. 3 is a perspective view illustrating a configuration of another secondary battery (laminated film type) including the electrolytic solution according to the embodiment of the present technology.

FIG. 4 is a cross-sectional view taken along a line IV-IV of a spirally wound electrode body illustrated in FIG. 3.

FIG. 5 is a block diagram illustrating a configuration of an application example (battery pack) of the secondary battery.

FIG. 6 is a block diagram illustrating a configuration of an application example (electric vehicle) of the secondary battery.

FIG. 7 is a block diagram illustrating a configuration of an application example (electric power storage system) of the secondary battery.

FIG. 8 is a block diagram illustrating a configuration of an application example (electric power tool) of the secondary battery.

### DETAILED DESCRIPTION

Embodiments of the present application will be described below in detail with reference to the drawings.

1. Electrolytic solution and Secondary Battery

1-1. Lithium Ion Secondary Battery (Cylindrical Type)

1-2. Lithium Ion Secondary Battery (Laminated Film Type)

1-3. Lithium Metal Secondary Battery (Cylindrical Type and Laminated Film Type)

### 2. Applications of Secondary Battery

2-1. Battery Pack

2-2. Electric Vehicle

2-3. Electric Power Storage System

2-4. Electric Power Tool

### [1. Electrolytic Solution and Secondary Battery]

[1-1. Lithium Ion Secondary Battery (Cylindrical Type)]

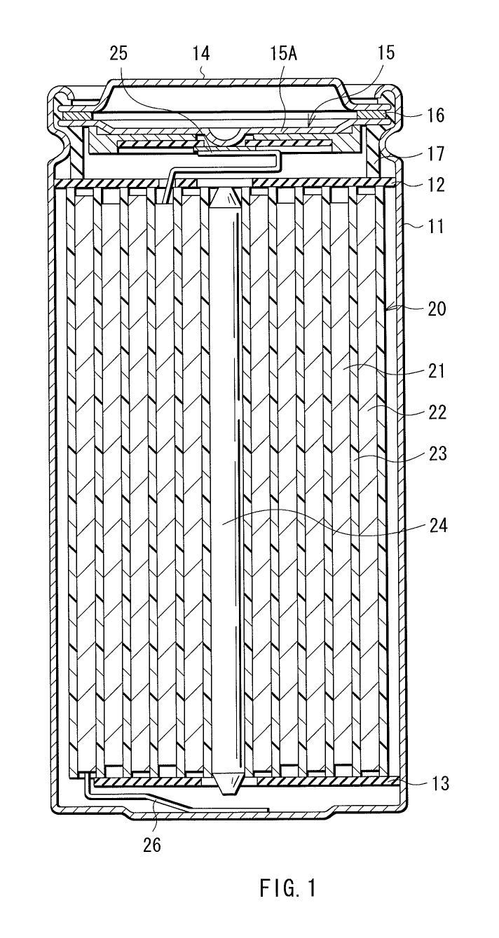

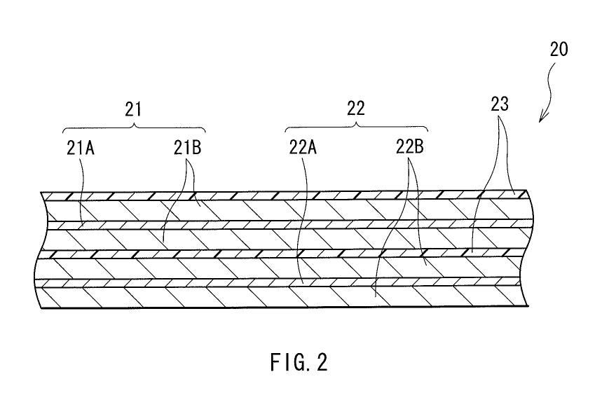

FIG. 1 and FIG. 2 illustrate cross-sectional configurations of a secondary battery using an electrolytic solution according to an embodiment of the present technology. FIG. 2 illustrates enlarged part of a spirally wound electrode body 20 illustrated in FIG. 1.

### [Whole Configuration of Secondary Battery]

The secondary battery is, for example, a lithium secondary battery (lithium ion secondary battery) in which the capacity of an anode 22 is obtained by insertion and extraction of lithium (lithium ions) as an electrode reactant. The lithium ion secondary battery will be hereinafter simply referred to as “secondary battery” as well.

The secondary battery herein described is, what we call a cylindrical type secondary battery. The secondary battery contains the spirally wound electrode body 20 and a pair of insulating plates 12 and 13 inside a battery can 11 in the shape of a substantially hollow cylinder. In the spirally wound electrode body 20, for example, a cathode 21 and the anode 22 are layered with a separator 23 in between and are spirally wound.

The battery can 11 has a hollow structure in which one end of the battery can 11 is closed and the other end thereof is opened. The battery can 11 may be made of, for example, iron, aluminum, an alloy thereof, or the like. The surface of the battery can 11 may be plated with a metal material such as nickel. The pair of insulating plates 12 and 13 is arranged to sandwich the spirally wound electrode body 20 in between, and to extend perpendicularly to the spirally wound periphery surface.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. In the PTC device 16, as temperature rises, its resistance is increased accordingly. The gasket 17 may be made of, for example, an insulating material. The surface of the gasket 17 may be coated with asphalt.

In the center of the spirally wound electrode body 20, a center pin 24 may be inserted. For example, a cathode lead 25 made of a conductive material such as aluminum is connected to the cathode 21. For example, an anode lead 26 made of a conductive material such as nickel is connected to the anode 22. The cathode lead 25 is, for example, welded to the safety valve mechanism 15, and is electrically connected to the battery cover 14. The anode lead 26 is, for example, welded to the battery can 11, and is electrically connected to the battery can 11.

### [Cathode]

In the cathode 21, for example, a cathode active material layer 21B is provided on a single surface or both surfaces of a cathode current collector 21A. The cathode current collector 21A may be made of, for example, a conductive material such as aluminum, nickel, and stainless steel.

The cathode active material layer 21B contains, as cathode active materials, one, or two or more of cathode materials capable of inserting and extracting lithium ions. As necessary, the cathode active material layer 21B may contain other material such as a cathode binder and a cathode electric conductor.

The cathode material is preferably a lithium-containing compound, since thereby high energy density is obtained. Examples of the lithium-containing compound include a composite oxide containing lithium and a transition metal element as constituent elements (lithium-transition metal composite oxide) and a phosphate compound containing lithium and a transition metal element as constituent elements (lithium-transition metal phosphate compound). Specially, it is preferable that the transition metal element be one, or two or more of cobalt, nickel, manganese, iron, and the like, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of the lithium-transition metal composite oxide include LiₓCoO₂, LiₓNiO₂, and a lithium-nickel-based composite oxide represented by Formula (20) described below. Examples of the lithium-transition metal phosphate compound include LiFePO₄ and LiFe₁₋ᵤMnᵤPO₄ (u<1), since thereby a high battery capacity is obtained and superior cycle characteristics are obtained. As a cathode material, a material other than the foregoing materials may be used.

LiNi_{1-z}M_{z}O2 (20)

In Formula (20), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb. z is in the range of 0.005<z<0.5.

In addition, the cathode material may be, for example, an oxide, a disulfide, a chalcogenide, a conductive polymer, or the like. Examples of the oxide include titanium oxide, vanadium oxide, and manganese dioxide. Examples of the disulfide include titanium disulfide and molybdenum sulfide. Examples of the chalcogenide include niobium selenide. Examples of the conductive polymer include sulfur, polyaniline, and polythiophene.

Examples of the cathode binder include one, or two or more of synthetic rubbers, polymer materials, and the like. Examples of the synthetic rubber include a styrene butadiene-based rubber, a fluorine-based rubber, and ethylene propylene diene. Examples of the polymer material include polyvinylidene fluoride and polyimide.

Examples of the cathode electric conductor include one, or two or more of carbon materials and the like. Examples of the carbon materials include graphite, carbon black, acetylene black, and Ketjen black. The cathode electric conductor may be a metal material, a conductive polymer, or the like as long as the material has electric conductivity.

### [Anode]

In the anode 22, for example, an anode active material layer 22B is provided on a single surface or both surfaces of an anode current collector 22A.

The anode current collector 22A may be made of, for example, a conductive material such as copper, nickel, and stainless steel. The surface of the anode current collector 22A is preferably roughened. Thereby, due to what we call an anchor effect, adhesion characteristics of the anode active material layer 22B with respect to the anode current collector 22A are improved. In this case, it is enough that the surface of the anode current collector 22A in the region opposed to the anode active material layer 22B is roughened at minimum. Examples of roughening methods include a method of forming fine particles by electrolytic treatment. The electrolytic treatment is a method of providing concavity and convexity by forming fine particles on the surface of the anode current collector 22A by an electrolytic method in an electrolytic bath. A copper foil aimed by an electrolytic method is generally called “electrolytic copper foil.”

The anode active material layer 22B contains one, or two or more of anode materials capable of inserting and extracting lithium ions as anode active materials, and may also contain other material such as an anode binder and an anode electric conductor as necessary. Details of the anode binder and the anode electric conductor are, for example, respectively similar to those of the cathode binder and the cathode electric conductor. In the anode active material layer 22B, the chargeable capacity of the anode material is preferably larger than the discharge capacity of the cathode 21 in order to prevent unintentional precipitation of lithium metal at the time of charge and discharge, for example.

Examples of the anode material include a carbon material. In the carbon material, its crystal structure change at the time of insertion and extraction of lithium ions is extremely small. Therefore, the carbon material provides high energy density and superior cycle characteristics. Further, the carbon material functions as an anode electric conductor as well. Examples of the carbon material include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon material include pyrolytic carbons, cokes, glassy carbon fiber, an organic polymer compound fired body, activated carbon, and carbon blacks. Of the foregoing, examples of the cokes include pitch coke, needle coke, and petroleum coke. The organic polymer compound fired body is obtained by firing (carbonizing) a polymer compound such as a phenol resin and a furan resin at an appropriate temperature. In addition, the carbon material may be low crystalline carbon or amorphous carbon heat-treated at temperature equal to or lower than about 1000 deg C. The shape of the carbon material may be any of a fibrous shape, a spherical shape, a granular shape, and a scale-like shape.

Further, the anode material may be, for example, a material (metal-based material) containing one, or two or more of metal elements and metalloid elements as constituent elements, since high energy density is thereby obtained. Such a metal-based material may be a simple substance, an alloy, or a compound, may be two or more thereof, or may have one or more phases thereof in part or all thereof “Alloy” includes a material containing one or more metal elements and one or more metalloid elements, in addition to a material configured of two or more metal elements. Further, the alloy may contain a nonmetallic element. Examples of the structure thereof include a solid solution, a eutectic crystal (eutectic mixture), an intermetallic compound, and a structure in which two or more thereof coexist.

The foregoing metal element and the foregoing metalloid element may be, for example, one, or two or more of metal elements and metalloid elements capable of forming an alloy with lithium. Specific examples thereof include Mg, B, Al, Ga, In, Si, Ge, Sn, Pb, Bi, Cd, Ag, Zn, Hf, Zr, Y, Pd, and Pt. Specially, Si or Sn or both are preferably used. Si and Sn have a high ability of inserting and extracting lithium ions, and therefore provide high energy density.

A material containing Si or Sn or both may be a simple substance, an alloy, or a compound of Si or Sn; two or more thereof; or a material having one, or two or more phases thereof in part or all thereof. The simple substance merely refers to a general simple substance (a small amount of impurity may be therein contained), and does not necessarily refer to a purity 100% simple substance.

Examples of the alloys of Si include a material containing one, or two or more of elements such as Sn, Ni, Cu, Fe, Co, Mn, Zn, In, Ag, Ti, Ge, Bi, Sb, and Cr as constituent elements other than Si. Examples of the compounds of Si include a material containing C or O as a constituent element other than Si. For example, the compounds of Si may contain one, or two or more of the elements described for the alloys of Si as constituent elements other than Si.

Examples of the alloys and the compounds of Si include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. v in SiOᵥ may be in the range of 0.2<v<1.4.

Examples of the alloys of Sn include a material containing one, or two or more of elements such as Si, Ni, Cu, Fe, Co, Mn, Zn, In, Ag, Ti, Ge, Bi, Sb, and Cr as constituent elements other than Sn. Examples of the compounds of Sn include a material containing C or O as a constituent element. The compounds of Sn may contain, for example, one, or two or more of the elements described for the alloys of Sn as constituent elements other than Sn. Examples of the alloys and the compounds of Sn include SnO_{w} (0<w≦2), SnSiO₃, LiSnO, and Mg₂Sn.

Further, as a material containing Sn, for example, a material containing a second constituent element and a third constituent element in addition to Sn as a first constituent element is preferable. Examples of the second constituent element include one, or two or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element include one, or two or more of B, C, Al, P, and the like. In the case where the second constituent element and the third constituent element are contained, a high battery capacity, superior cycle characteristics, and the like are obtained.

Specially, a material containing Sn, Co, and C (SnCoC-containing material) is preferable. The composition of the SnCoC-containing material is, for example, as follows. That is, the C content is from 9.9 mass % to 29.7 mass % both inclusive, and the ratio of Sn and Co contents (Co/(Sn+Co)) is from 20 mass % to 70 mass % both inclusive, since high energy density is obtained in such a composition range.

It is preferable that the SnCoC-containing material have a phase containing Sn, Co, and C. Such a phase is preferably low-crystalline or amorphous. The phase is a reaction phase capable of reacting with lithium. Due to existence of the reaction phase, superior characteristics are obtained. The half bandwidth of the diffraction peak obtained by X-ray diffraction of the phase is preferably equal to or greater than 1.0 deg based on diffraction angle of 2θ in the case where CuKα ray is used as a specific X ray, and the insertion rate is 1 deg/min. Thereby, lithium ions are more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with lithium is allowed to be easily determined by comparison between X-ray diffraction charts before and after electrochemical reaction with lithium. For example, if the position of the diffraction peak after electrochemical reaction with lithium is changed from the position of the diffraction peak before the electrochemical reaction with lithium, the obtained diffraction peak corresponds to the reaction phase capable of reacting with lithium. In this case, for example, the diffraction peak of the low crystalline reaction phase or the amorphous reaction phase is seen in the range of 2θ=from 20 to 50 deg both inclusive. Such a reaction phase has, for example, the foregoing respective constituent elements, and the low crystalline or amorphous structure thereof possibly results from existence of carbon mainly.

In the SnCoC-containing material, part or all of carbon as a constituent element are preferably bonded to a metal element or a metalloid element as other constituent element, since thereby cohesion or crystallization of tin and/or the like is suppressed. The bonding state of elements is allowed to be checked by, for example, X-ray photoelectron spectroscopy (XPS). In a commercially available device, for example, as a soft X ray, Al—Kα ray, Mg—Kα ray, or the like is used. In the case where part or all of carbon are bonded to a metal element, a metalloid element, or the like, the peak of a synthetic wave of 1s orbit of carbon (C1s) is shown in a region lower than 284.5 eV. In the device, energy calibration is made so that the peak of 4 f orbit of gold atom (Au4 f) is obtained in 84.0 eV. At this time, in general, since surface contamination carbon exists on the material surface, the peak of C1s of the surface contamination carbon is regarded as 284.8 eV, which is used as the energy reference. In XPS measurement, the waveform of the peak of C1s is obtained as a form including the peak of the surface contamination carbon and the peak of carbon in the SnCoC-containing material. Therefore, for example, analysis is made by using commercially available software to isolate both peaks from each other. In the waveform analysis, the position of the main peak existing on the lowest bound energy side is the energy reference (284.8 eV).

It is to be noted that the SnCoC-containing material may further contain, for example, one, or two or more of elements such as Si, Fe, Ni, Cr, In, Nb, Ge, Ti, Mo, Al, P, Ga, and Bi as necessary.

In addition to the SnCoC-containing material, a material containing Sn, Co, Fe, and C (SnCoFeC-containing material) is also preferable. The composition of the SnCoFeC-containing material may be arbitrarily set. For example, the composition in which the Fe content is set small is as follows. That is, the C content is from 9.9 mass % to 29.7 mass % both inclusive, the Fe content is from 0.3 mass % to 5.9 mass % both inclusive, and the ratio of contents of Sn and Co (Co/(Sn+Co)) is from 30 mass % to 70 mass % both inclusive. Further, for example, the composition in which the Fe content is set large is as follows. That is, the C content is from 11.9 mass % to 29.7 mass % both inclusive, the ratio of contents of Sn, Co, and Fe ((Co+Fe)/(Sn+Co+Fe)) is from 26.4 mass % to 48.5 mass % both inclusive, and the ratio of contents of Co and Fe (Co/(Co+Fe)) is from 9.9 mass % to 79.5 mass % both inclusive. In such a composition range, high energy density is obtained. The physical properties (half bandwidth and the like) of the SnCoFeC-containing material are similar to those of the foregoing SnCoC-containing material.

In addition, the anode material may be, for example, a metal oxide, a polymer compound, or the like. Examples of the metal oxide include iron oxide, ruthenium oxide, and molybdenum oxide. Examples of the polymer compound include polyacetylene, polyaniline, and polypyrrole.

The anode active material layer 22B is formed by, for example, a coating method, a vapor-phase deposition method, a liquid-phase deposition method, a spraying method, a firing method (sintering method), or a combination of two or more of these methods. The coating method is a method in which, for example, after a particulate anode active material is mixed with an anode binder and/or the like, the mixture is dispersed in a solvent such as an organic solvent, and the anode current collector is coated with the resultant. Examples of the vapor-phase deposition method include a physical deposition method and a chemical deposition method. Specifically, examples thereof include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method include an electrolytic plating method and an electroless plating method. The spraying method is a method in which an anode active material in a fused state or a semi-fused state is sprayed. The firing method is, for example, a method in which after the anode current collector is coated by a coating method, heat treatment is performed at a temperature higher than the melting point of the anode binder and/or the like. Examples of the firing method include a publicly-known technique such as an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting lithium ions is larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case that the open circuit voltage is 4.20 V even if the same cathode active material is used. Therefore, amounts of the cathode active material and the anode active material are adjusted accordingly. Thereby, high energy density is obtainable.

### [Separator]

The separator 23 separates the cathode 21 from the anode 22, and passes lithium ions while preventing current short circuit resulting from contact of both electrodes. The separator 23 is, for example, a porous film made of a synthetic resin or ceramics. The separator 23 may be a laminated film in which two or more types of porous films are laminated. Examples of the synthetic resin include polytetrafluoroethylene, polypropylene, and polyethylene.

In particular, the separator 23 may include, for example, a base material layer configured of the foregoing porous film and a polymer compound layer provided on one surface or both surfaces of the base material layer. Thereby, adhesion characteristics of the separator 23 with respect to the cathode 21 and the anode 22 are improved, and therefore skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance of the secondary battery is less likely to be increased, and battery swollenness is suppressed.

The polymer compound layer contains, for example, a polymer material such as polyvinylidene fluoride, since such a polymer material has a superior physical strength and is electrochemically stable. However, the polymer material may be a material other than polyvinylidene fluoride. The polymer compound layer is formed as follows, for example. That is, after a solution in which the polymer material is dissolved is prepared, the surface of the base material layer is coated with the solution, and the resultant is subsequently dried. Alternatively, the base material layer may be soaked in the solution and may be subsequently dried.

### [Electrolytic Solution/Cyano Cyclic Ester Carbonate]

The separator 23 is impregnated with an electrolytic solution as a liquid electrolyte. The electrolytic solution contains one, or two or more of cyano cyclic ester carbonates represented by Formula (1) described below. However, the electrolytic solution may contain other material such as a solvent and an electrolyte salt.

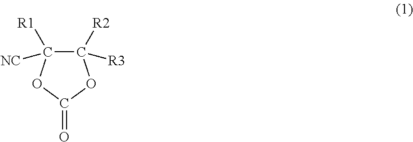

In Formula (1), each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group. Arbitrary two or more of R1 to R3 may be bonded to each other. However, in the case where the total number of cyano groups is 1, one or more of R1 to R3 each are a halogen group, a monovalent halogenated hydrocarbon group, or a monovalent halogenated oxygen-containing hydrocarbon group.

The cyano cyclic ester carbonate is a cyclic ester carbonate having one or more cyano groups in principle. However, in some cases, the cyano cyclic ester carbonate may further have a halogen group, a monovalent halogenated hydrocarbon group, or a monovalent halogenated oxygen-containing hydrocarbon group depending on the total number of cyano groups. For a relation between the total number of cyano groups and presence or absence of a halogen group or the like, a description will be given later.

The electrolytic solution contains the cyano cyclic ester carbonate. One reason for this is that, since in this case, the chemical stability of the electrolytic solution is improved, a decomposition reaction of the electrolytic solution is suppressed at the time of charge and discharge. More specifically, in this case, at the time of charge and discharge, a rigid film resulting from the cyano cyclic ester carbonate is mainly formed on the surface of the anode 22, and therefore a decomposition reaction of the electrolytic solution due to existence of the highly-reactive anode 22 is suppressed. Thereby, even if the secondary battery is repeatedly charged and discharged, or the secondary battery is stored, lowering of the discharge capacity is suppressed. Such a tendency is particularly significant in the case where the secondary battery is charged, discharged, and stored in a severe environment such as a high-temperature environment and a low-temperature environment.

Each type of R1 to R3 is not particularly limited as long as each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group as described above. R1 to R3 may be the same type of group, or may be groups different from each other. Arbitrary two of R1 to R3 may be the same type of group. Arbitrary two or more of R1 to R3 may be bonded to each other, and the bonded groups may form a ring structure.

However, in the case where the total number of cyano groups is 1, one or more of R1 to R3 each are typically a halogen group, a monovalent halogenated hydrocarbon group, or a monovalent halogenated oxygen-containing hydrocarbon group.

More specifically, as seen in Formula (1), the cyano cyclic ester carbonate has one cyano group differently from R1 to R3. Each of R1 to R3 may be a cyano group differently from the exiting cyano group. Therefore, the cyano cyclic ester carbonate is allowed to have four cyano groups at maximum as a whole. Accordingly, in the cyano cyclic ester carbonate, in the case where the total number of cyano groups is 1 (in the case where all of R1 to R3 each are not a cyano group, and the exiting cyano group is only cyano group), one or more of R1 to R3 each are typically a halogen group and/or the like. Meanwhile, in the case where the total number of cyano groups is equal to or larger than 2 (in the case where one or more of R1 to R3 each are a cyano group in addition to the exiting cyano group), each of R1 to R3 may be one of a halogen group and the like, and is not necessarily one of a halogen group and the like. That is, in the case where the total number of cyano groups is equal to or larger than 2, a halogen group and/or the like may exist, or does not necessarily exist.

“Hydrocarbon group” is a generic term used to refer to groups configured of carbon and hydrogen, and may have a straight-chain structure or a branched structure having one, or two or more side chains. “Halogenated hydrocarbon group” is obtained by substituting part or all of hydrogen groups in the foregoing hydrocarbon group with a halogen group. Type of the halogen group thereof is as follows.

The halogen group is, for example, one of a fluorine group (—F), a chlorine group (—Cl), a bromine group (—Br), an iodine group (—I), and the like. Specially, the fluorine group is preferable, since a film resulting from the cyano cyclic ester carbonate is thereby easily formed.

Examples of the monovalent hydrocarbon group include an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, and a cycloalkyl group with carbon number from 3 to 18 both inclusive. Further, the monovalent halogenated hydrocarbon group is obtained by halogenating the foregoing alkyl group or the like, that is, obtained by substituting part or all of hydrogen groups of the alkyl group or the like by a halogen group, since the foregoing advantage is thereby obtained while the solubility, the compatibility, and the like of the cyano cyclic ester carbonate are secured.

More specific examples of the alkyl group include a methyl group (—CH₃), an ethyl group (—C₂H₅), and a propyl group (—C₃H₇). Examples of the alkenyl group include a vinyl group (—CH═CH₂) and an allyl group (—CH₂—CH═CH₂). Examples of the alkynyl group include an ethynyl group (—C≡CH). Examples of the aryl group include a phenyl group and a naphtyl group. Examples of the cycloalkyl group include a cyclopropyl group, a cyclobutyl group, a cyclopentyl group, a cyclohexyl group, a cycloheptyl group, and a cyclooctyl group. Examples of the group obtained by halogenating an alkyl group or the like include a trifluoromethyl group (—CF₃) and a pentafluoroethyl group (—C₂F₅).

“Oxygen-containing hydrocarbon group” is a group configured of oxygen together with carbon and hydrogen. “Halogenated oxygen-containing hydrocarbon group” is a group obtained by substituting part or all of the foregoing oxygen-containing hydrocarbon group with a halogen group, and type of the halogen group is as described above.

Examples of the monovalent oxygen-containing hydrocarbon group include an alkoxy group with carbon number from 1 to 12 both inclusive. Further, the monovalent halogenated oxygen-containing hydrocarbon group is obtained by substituting part or all of the foregoing alkoxy group or the like by a halogen group, since the foregoing advantage is thereby obtained while the solubility, the compatibility, and the like of the cyano cyclic ester carbonate are secured.

More specific examples of the alkoxy group include a methoxy group (—OCH₃) and an ethoxy group (—OC₂H₅). Examples of the group obtained by halogenating an alkoxy group or the like include a trifluoromethoxy group (—OCF₃) and a pentafluoroethoxy group (—OC₂F₅).

It is to be noted that each of R1 to R3 may be a group other than the foregoing groups. Specifically, each of R1 to R3 may be a derivative of each of the foregoing groups. The derivative is obtained by introducing one, or two or more substituent groups to each of the foregoing groups. Substituent group type may be arbitrary.

Specific examples of the cyano cyclic ester carbonate include compounds represented by Formula (1-1) to Formula (1-24) described below. Such compounds include an geometric isomer. However, the cyano cyclic ester carbonate may be other compound corresponding to Formula (1).

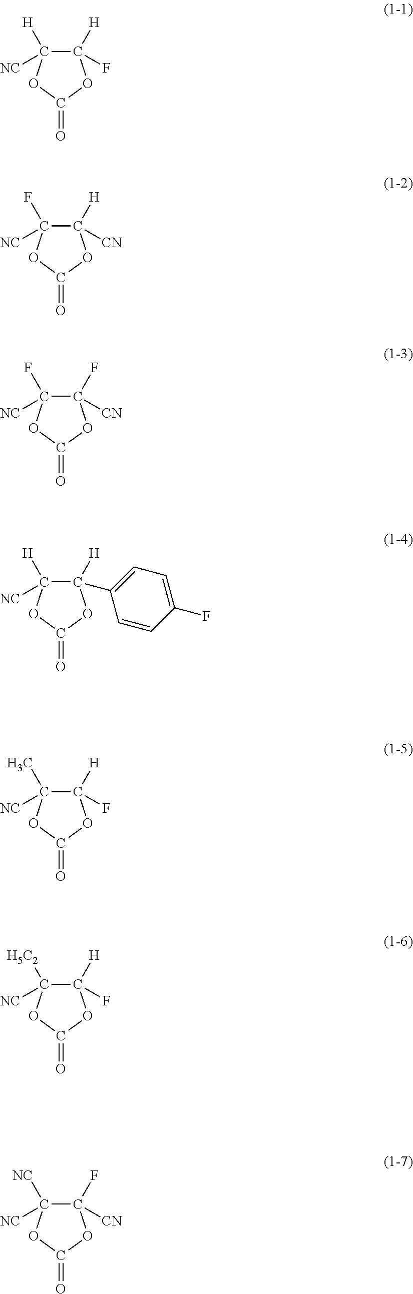

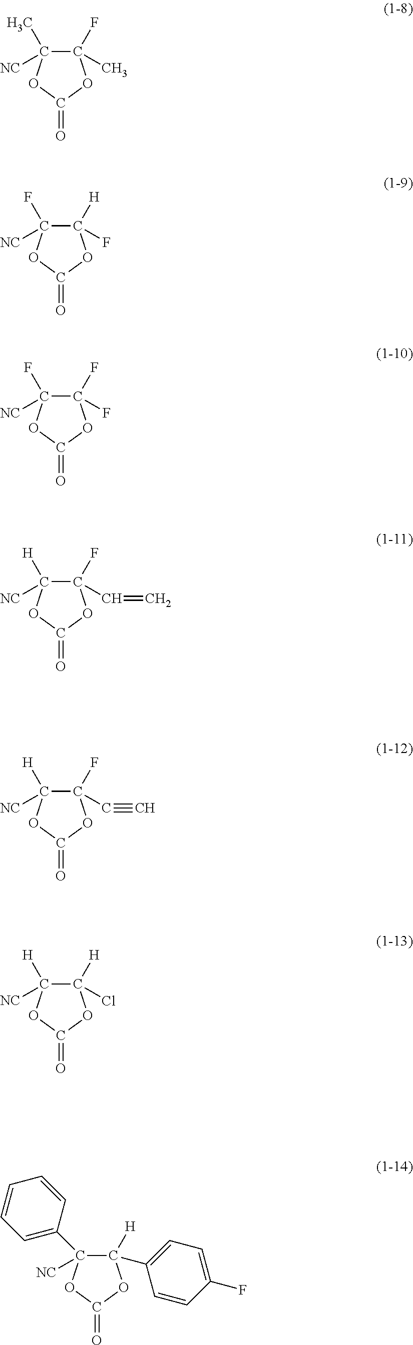

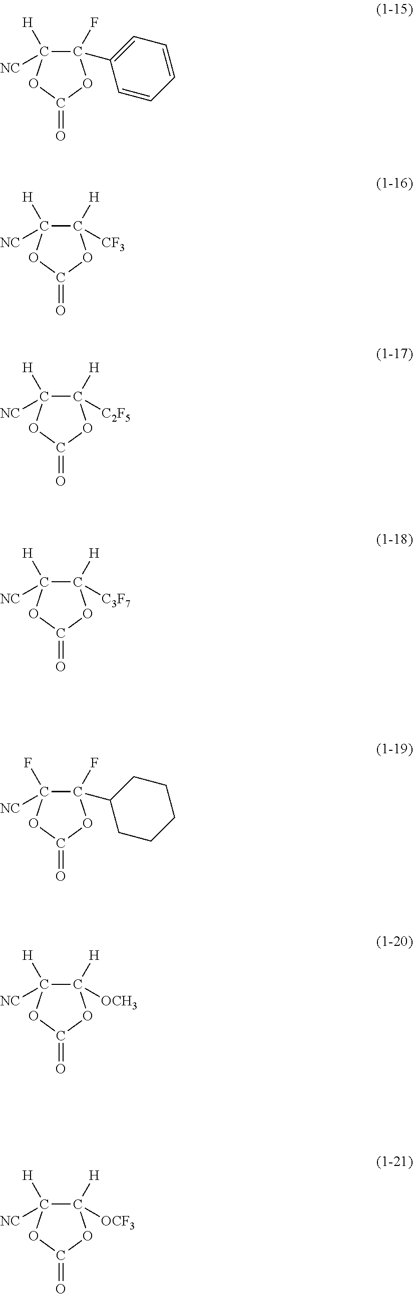

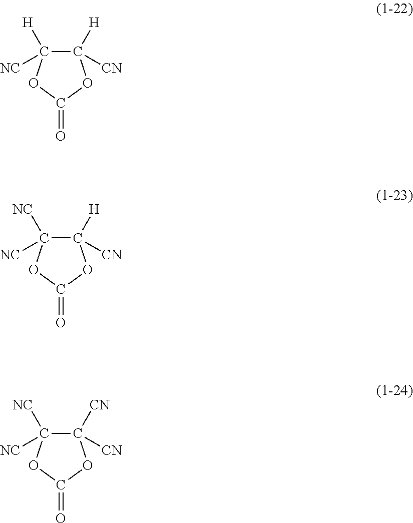 [SMILES: N#CC1OC(=O)OC1C#N ; N#CC1OC(=O)OC1(C#N)C#N ; N#CC1(C#N)OC(=O)OC1(C#N)C#N]

Although the content of the cyano cyclic ester carbonate in the electrolytic solution is not particularly limited, specially, the content thereof is preferably from 0.01 wt % to 20 wt % both inclusive, since higher effects are thereby obtained.

### [Auxiliary Compound]

The electrolytic solution preferably contains one or more of compounds (auxiliary compounds) represented by Formula (2) to Formula (6) described below together with the cyano cyclic ester carbonate. One reason for this is that the chemical stability of the electrolytic solution is thereby more improved, and therefore a decomposition reaction of the electrolytic solution is more suppressed. The word “auxiliary” of the auxiliary compound refers to that the compound is used together with the cyano cyclic ester carbonate.

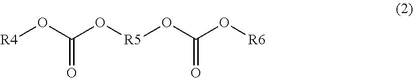

In Formula (2), each of R4 and R6 is one of a monovalent hydrocarbon group, a monovalent halogenated hydrocarbon group, a monovalent oxygen-containing hydrocarbon group, and a monovalent halogenated oxygen-containing hydrocarbon group. R5 is one of a divalent hydrocarbon group, a divalent halogenated hydrocarbon group, a divalent oxygen-containing hydrocarbon group, and a divalent halogenated oxygen-containing hydrocarbon group.

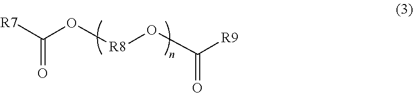

In Formula (3), each of R7 and R9 is one of a monovalent hydrocarbon group, a monovalent halogenated hydrocarbon group, a monovalent oxygen-containing hydrocarbon group, and a monovalent halogenated oxygen-containing hydrocarbon group. R8 is one of a divalent hydrocarbon group, a divalent halogenated hydrocarbon group, a divalent oxygen-containing hydrocarbon group, and a divalent halogenated oxygen-containing hydrocarbon group. n is an integer number equal to or greater than 1.

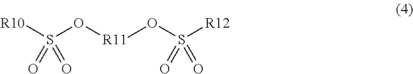

In Formula (4), each of R10 and R12 is one of a monovalent hydrocarbon group, a monovalent halogenated hydrocarbon group, a monovalent oxygen-containing hydrocarbon group, and a monovalent halogenated oxygen-containing hydrocarbon group. R11 is one of a divalent hydrocarbon group, a divalent halogenated hydrocarbon group, a divalent oxygen-containing hydrocarbon group, and a divalent halogenated oxygen-containing hydrocarbon group.

Li₂PFO₃ (5)

LiPF₂O₂ (6)

### [Dicarbonic Ester Compound]

The auxiliary compound represented by Formula (2) is a dicarbonic ester compound having ester carbonate groups (—O—C(═O)—O—R4 and —O—C(═O)—O—R6) on both ends thereof.

Each type of R4 and R6 is not particularly limited as long as each of R4 and R6 is one of a monovalent hydrocarbon group, a monovalent halogenated hydrocarbon group, a monovalent oxygen-containing hydrocarbon group, and a monovalent halogenated oxygen-containing hydrocarbon group. One reason for this is that, in this case, since the dicarbonic ester compound has two ester carbonate groups, the foregoing advantage is obtainable without depending on the types of R4 and R6. It is to be noted that R4 and R6 may be the same type of group, or may be groups different from each other.

Examples of each of the monovalent hydrocarbon group and the monovalent halogenated hydrocarbon group include an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and a group obtained by substituting part or all of hydrogen groups of each of the foregoing groups with a halogen group. Further, examples of each of the monovalent oxygen-containing hydrocarbon group and the monovalent halogenated oxygen-containing hydrocarbon group include an alkoxy group with carbon number from 1 to 12 both inclusive and a group obtained by substituting part or all of hydrogen groups thereof with a halogen group. One reason for this is that, in these cases, the foregoing advantage is obtained while the solubility, the compatibility, and the like of the dicarbonic ester compound are secured. Details of R4 and R6 other than the foregoing description are, for example, similar to those of R1 to R3.

Type of R5 is not particularly limited as long as R5 is one of a divalent hydrocarbon group, a divalent halogenated hydrocarbon group, a divalent oxygen-containing hydrocarbon group, and a divalent halogenated oxygen-containing hydrocarbon group as described above. One reason for this is that, in this case, the foregoing advantage is obtainable without depending on the type of R5 for the reason similar to that in the case of R4 and R6 described above.

Examples of the divalent hydrocarbon group include an alkylene group with carbon number from 1 to 12 both inclusive, an alkenylene group with carbon number from 2 to 12 both inclusive, an alkynylene group with carbon number from 2 to 12 both inclusive, an arylene group with carbon number from 6 to 18 both inclusive, a cycloalkylene group with carbon number from 3 to 18 both inclusive, a group containing an arylene group and an alkylene group, and a group obtained by substituting part or all of hydrogen groups of each of the foregoing groups with a halogen group. However, the group containing an arylene group and an alkylene group may be a group in which one arylene group is linked to one alkylene group, or may be a group in which two alkylene groups are linked to each other with an arylene group in between (aralkylene group). In this case, the carbon number of the alkylene group is preferably equal to or less than 12. Further, examples of the divalent halogenated hydrocarbon group include a group obtained by substituting part or all of the foregoing alkylene group or the like with a halogen group. One reason for this is that, in this case, the foregoing advantage is obtained while the solubility, the compatibility, and the like of the dicarbonic ester compound are secured.

Examples of the divalent oxygen-containing hydrocarbon group include a group containing an ether bond and an alkylene group. However, the group containing an ether bond and an alkylene group may be a group in which one ether bond is linked to one alkylene group, or may be a group in which two alkylene groups are linked to each other through an ether bond (aralkylene group). In this case, the carbon number of the alkylene group is preferably equal to or less than 12. Further, examples of the divalent halogenated oxygen-containing hydrocarbon group include a group obtained by substituting part or all of the foregoing group containing an ether bond and an alkylene group or the like with a halogen group. One reason for this is that, in this case, the foregoing advantage is obtained while the solubility, the compatibility, and the like of the dicarbonic ester compound are secured.

Specific examples of R5 include straight-chain alkylene groups represented by Formula (2-13) to Formula (2-19) described below, branched alkylene groups represented by Formula (2-20) to Formula (2-28) described below, arylene groups represented by Formula (2-29) to Formula (2-31) described below, and divalent groups containing an arylene group and an alkylene group (benzylidene group) represented by Formula (2-32) to Formula (2-34) described below.

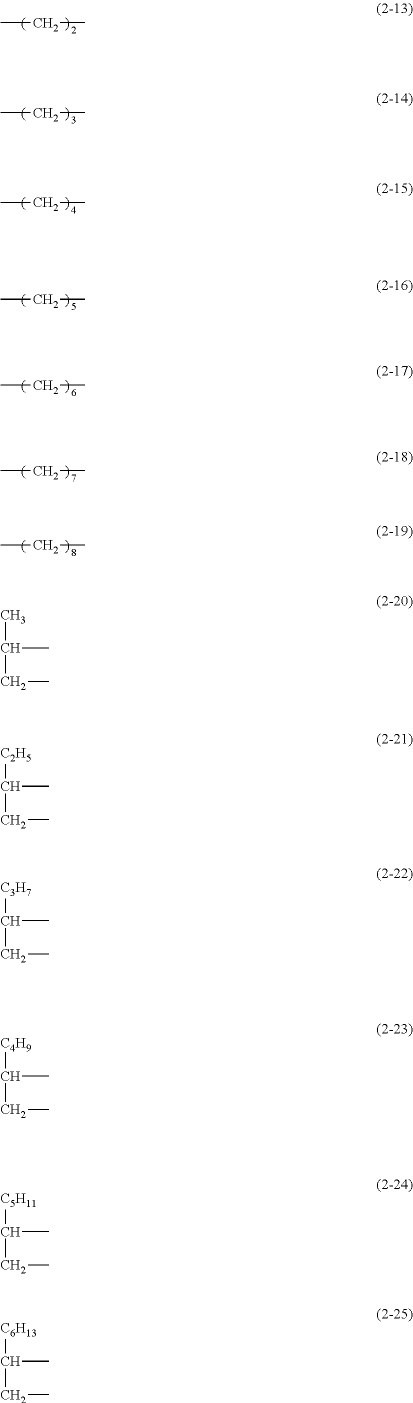

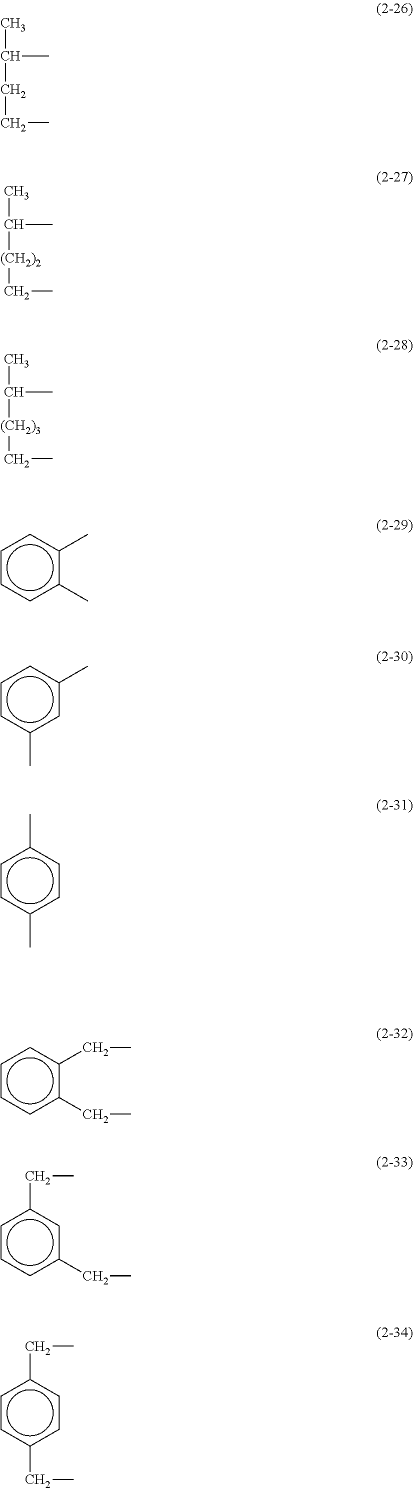

Further, as the group containing an ether bond and an alkylene group, a group in which an ether bond and an alkylene group are alternately linked, and both ends are alkylene groups (alternate linking groups) is preferable. The carbon number of the alternate linking groups is preferably from 4 to 12 both inclusive, since superior solubility and superior compatibility are thereby obtained. However, the number of ether bonds, the number of alkylene groups, the linkage order thereof, and the like are arbitrarily changeable.

Specific examples of R5 that is an alternate linking group include groups represented by Formula (2-35) to Formula (2-47) described below. Further, examples of groups obtained by halogenating the alternate linking groups represented by Formula (2-35) to Formula (2-47) include groups represented by Formula (2-48) to Formula (2-56). Specially, the groups represented by Formula (2-40) to Formula (2-42) are preferable.

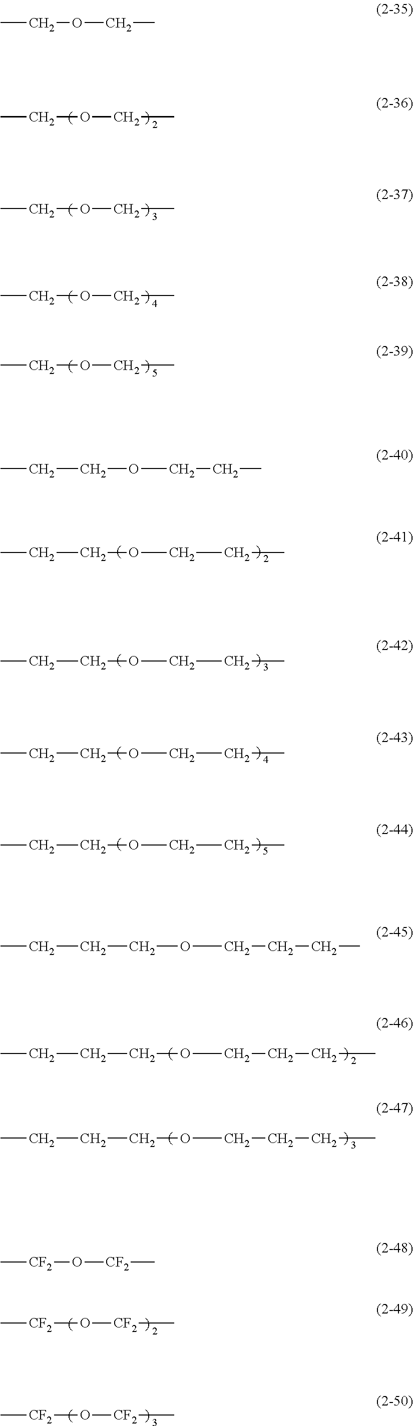

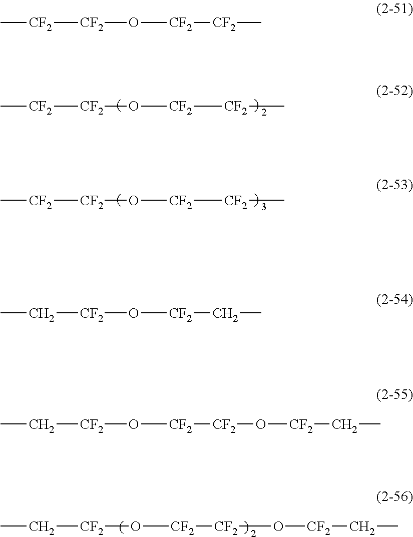

Although the molecular weight of the dicarbonic ester compound is not particularly limited, specially, the molecular weight of the dicarbonic ester compound is preferably from 200 to 800 both inclusive, is more preferably from 200 to 600 both inclusive, and is further more preferably from 200 to 450 both inclusive. One reason for this is that superior solubility and superior compatibility are thereby obtained.

Specific examples of the dicarbonic ester compound include compounds represented by Formula (2-1) to Formula (2-12) described below, since sufficient solubility and sufficient compatibility are thereby obtained, and the chemical stability of the electrolytic solution is thereby sufficiently improved. However, other compound corresponding to Formula (2) may be used.

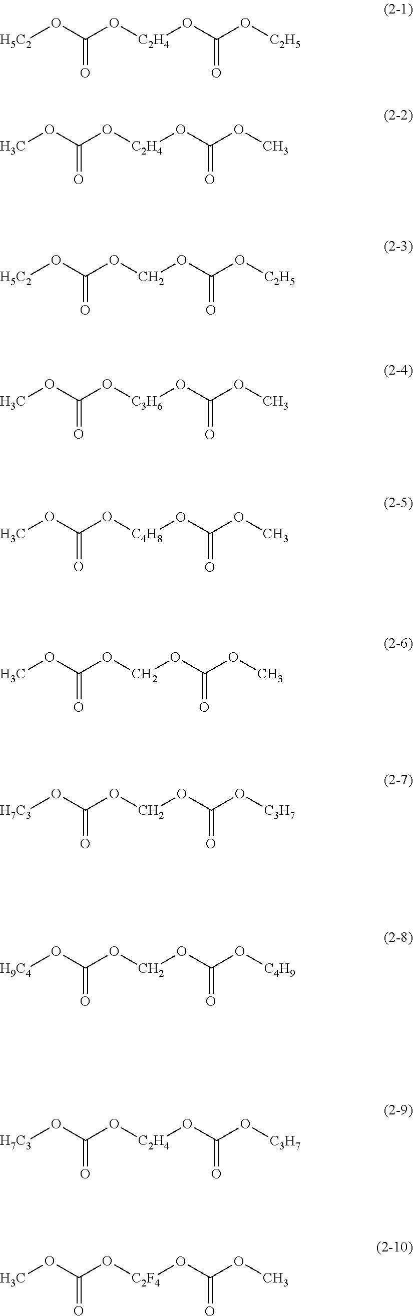

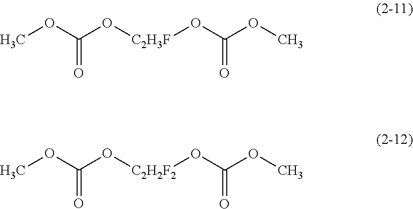

### [Dicarboxylic Compound]

The auxiliary compound represented by Formula (3) is a dicarboxylic compound having carboxylic ester groups (—O—C(═O)—R7 and —O—C(═O)—R9) on both ends thereof as described above.

Each type of R7 and R9 is not particularly limited as long as each of R7 and R9 is one of a monovalent hydrocarbon group, a monovalent halogenated hydrocarbon group, a monovalent oxygen-containing hydrocarbon group, and a monovalent halogenated oxygen-containing hydrocarbon group as described above. Type of R8 is not particularly limited as long as R8 is one of a divalent hydrocarbon group, a divalent halogenated hydrocarbon group, a divalent oxygen-containing hydrocarbon group, and a divalent halogenated oxygen-containing hydrocarbon group as described above. One reason for this is that, in this case, since the dicarboxylic compound has two carboxylic groups, the foregoing advantage is obtainable without depending on the types of R7 to R9. It is to be noted that R7 and R9 may be the same type of group, or may be groups different from each other. A value of n may be arbitrary as long as n is an integer number equal to or greater than 1. Details of R7 to R9 are, for example, similar to those of R4 to R6.

Although the molecular weight of the dicarboxylic compound is not particularly limited, specially, the molecular weight of the dicarboxylic compound is preferably from 162 to 1000 both inclusive, is more preferably from 162 to 500 both inclusive, and is further more preferably from 162 to 300 both inclusive. One reason for this is that superior solubility and superior compatibility are thereby obtained.

Specific examples of the dicarboxylic compound include compounds represented by Formula (3-1) to Formula (3-17) described below, since sufficient solubility and sufficient compatibility are thereby obtained, and the chemical stability of the electrolytic solution is sufficiently improved. However, other compound corresponding to Formula (3) may be used.

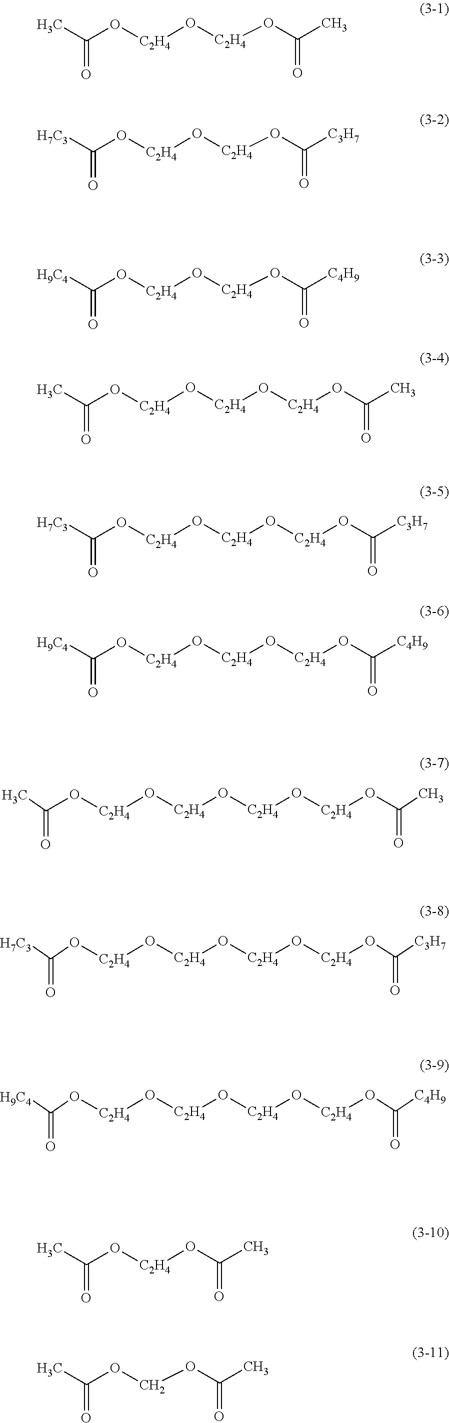

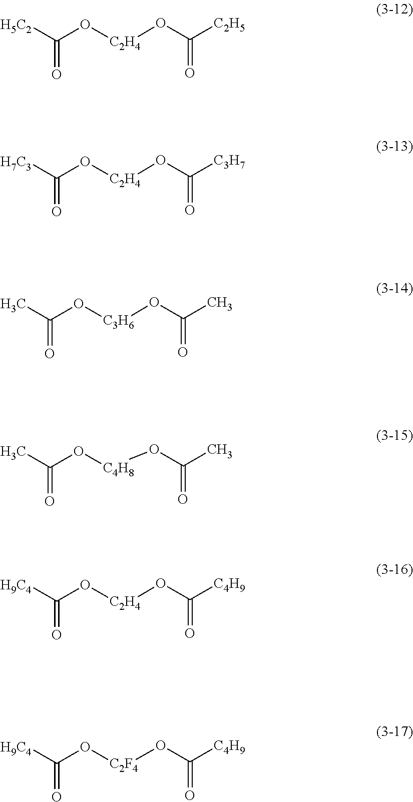

### [Disulfonic Compound]

The auxiliary compound represented by Formula (4) is a disulfonic compound having sulfonic ester groups (—O—S(═O)₂—R10 and —O—S(═O)₂—R12) on both ends thereof.

Each type of R10 and R12 is not particularly limited as long as each of R10 and R12 is one of a monovalent hydrocarbon group, a monovalent halogenated hydrocarbon group, a monovalent oxygen-containing hydrocarbon group, and a monovalent halogenated oxygen-containing hydrocarbon group as described above. Further, type of R11 is not particularly limited as long as R11 is one of a divalent hydrocarbon group, a divalent halogenated hydrocarbon group, a divalent oxygen-containing hydrocarbon group, and a divalent halogenated oxygen-containing hydrocarbon group as described above. One reason for this is that, in this case, since the disulfonic compound has two sulfonic groups, the foregoing advantage is obtainable without depending on the types of R10 to R12. It is to be noted that R10 and R12 may be the same type of group, or may be groups different from each other. Details of R10 to R12 are, for example, similar to those of R4 to R6.

Although the molecular weight of the disulfonic compound is not particularly limited, specially, the molecular weight of the disulfonic compound is preferably from 200 to 800 both inclusive, is more preferably from 200 to 600 both inclusive, and is further more preferably from 200 to 450 both inclusive. One reason for this is that superior solubility and superior compatibility are thereby obtained.

Specific examples of the disulfonic compound include compounds represented by Formula (4-1) to Formula (4-9) described below, since sufficient solubility and sufficient compatibility are thereby obtained, and the chemical stability of the electrolytic solution is thereby sufficiently improved. However, other compound corresponding to Formula (4) may be used.

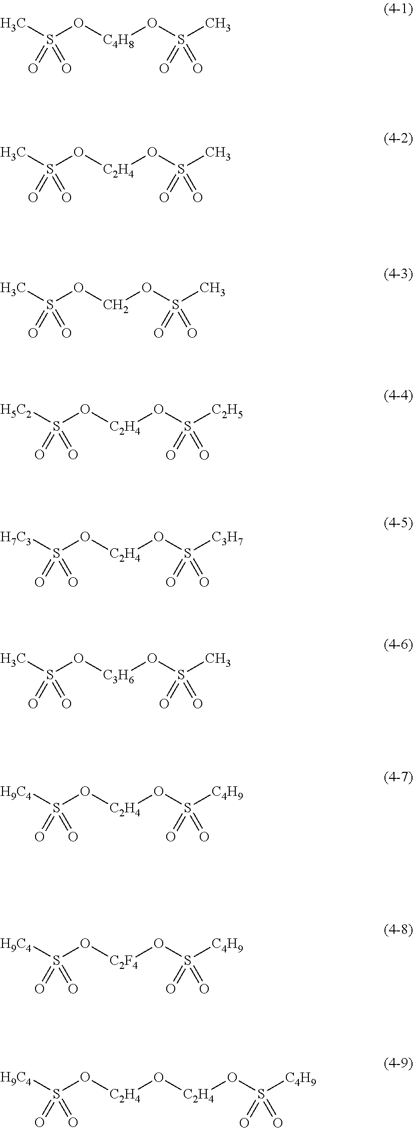

### [Fluoro Lithium Phosphate]

The auxiliary compound represented by Formula (5) is fluoro lithium phosphate (monofluoro lithium phosphate) containing one fluorine atom as a constituent element. The auxiliary compound represented by Formula (6) is fluoro lithium phosphate (difluoro lithium phosphate) containing two fluorine atoms as constituent elements.

Although the content of the auxiliary compound in the electrolytic solution is not particularly limited, specially, the content thereof is preferably from 0.001 wt % to 2 wt % both inclusive, and more preferably from 0.1 wt % to 1 wt % both inclusive since thereby a higher effect is obtainable.

### [Solvent]

The solvent contains one, or two or more of nonaqueous solvents such as an organic solvent (other than the foregoing cyano cyclic ester carbonate and the foregoing auxiliary compound).

Examples of the nonaqueous solvents include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Thereby, a superior battery capacity, superior cycle characteristics, superior storage characteristics, and the like are obtained.

Specially, one or more of ethylene carbonate, propylene carbonate, dimethyl carbonate, diethyl carbonate, and ethyl methyl carbonate are preferable, since thereby a superior battery capacity, superior cycle characteristics, superior storage characteristics, and the like are obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate is more preferable. One reason for this is that the dissociation property of the electrolyte salt and ion mobility are improved.

In particular, the solvent preferably contains one, or two or more of unsaturated cyclic ester carbonates represented by Formula (7) to Formula (9) described below. One reason for this is that a stable protective film is formed on the surface of the anode 22 mainly at the time of charge and discharge, and therefore a decomposition reaction of the electrolytic solution is suppressed. The “unsaturated cyclic ester carbonate” refers to a cyclic ester carbonate having one, or two or more unsaturated carbon bonds (carbon-carbon double bonds). The content of the unsaturated cyclic ester carbonate in the solvent is not particularly limited, and is, for example, from 0.01 wt % to 10 wt % both inclusive. However, specific examples of the unsaturated cyclic ester carbonate are not limited to the after-mentioned compounds, and other compounds corresponding to Formula (7) to Formula (9) may be used.

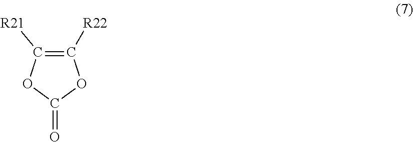

In Formula (7), each of R21 and R22 is one of a hydrogen group and an alkyl group.

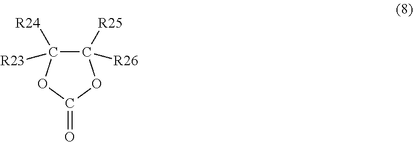

In Formula (8), each of R23 to R26 is one of a hydrogen group, an alkyl group, a vinyl group, and an allyl group. One or more of R23 to R26 each are a vinyl group or an allyl group.

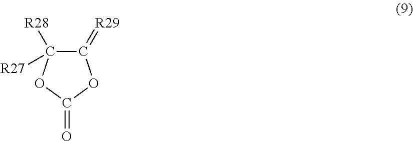

In Formula (9), each of R27 and R28 is one of a hydrogen group and an alkyl group. R29 is a group represented by ═CH—R30. R30 is one of a hydrogen group and an alkyl group.

The unsaturated cyclic ester carbonate represented by Formula (7) is a vinylene carbonate-based compound. Each type of 21 and R22 is not particularly limited as long as each of R21 and R22 is one of a hydrogen group and an alkyl group as described above. R21 and R22 may be the same type of group, or may be groups different from each other. Examples of the alkyl group include a methyl group and an ethyl group, and the carbon number of the alkyl group is preferably from 1 to 12 both inclusive, since superior solubility and superior compatibility are thereby obtained. Specific examples of the vinylene carbonate-based compounds include vinylene carbonate (1,3-dioxole-2-one), methylvinylene carbonate (4-methyl-1,3-dioxole-2-one), ethylvinylene carbonate (4-ethyl-1,3-dioxole-2-one), 4,5-dimethyl-1,3-dioxole-2-one, and 4,5-diethyl-1,3-dioxole-2-one. It is to be noted that each of R21 and R22 may be a group obtained by substituting part or all of hydrogen groups in the alkyl group with a halogen group. In this case, specific examples of the vinylene carbonate-based compounds include 4-fluoro-1,3-dioxole-2-one and 4-trifluoromethyl-1,3-dioxole-2-one. Specially, vinylene carbonate is preferable, since vinylene carbonate is easily available and provides a high effect.

The unsaturated cyclic ester carbonate represented by Formula (8) is a vinylethylene carbonate-based compound. Each type of R23 to R26 is not particularly limited as long as each of R23 to R26 is one of a hydrogen group, an alkyl group, a vinyl group, and an allyl group as described above, where one or more of R23 to R26 each are one of a vinyl group and an allyl group. R23 to R26 may be the same type of group, and may be groups different from each other. Alternatively, part of R23 to R26 may be the same type of group. The type and the carbon number of the alkyl group are similar to those of R21 and R22. Specific examples of the vinylethylene carbonate-based compounds include vinylethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. Specially, vinylethylene carbonate is preferable, since vinylethylene carbonate is easily available, and provides a high effect. It is needless to say that all of R23 to R26 may be a vinyl group or an allyl group. Alternatively, some of R23 to R26 may be a vinyl group, and the others thereof may be an allyl group.

The unsaturated cyclic ester carbonate represented by Formula (9) is a methylene ethylene carbonate-based compound. Each type of 27 and R28 is not particularly limited as long as each of R27 and R28 is one of a hydrogen group and an alkyl group. R27 and R28 may be the same type of group, or may be groups different from each other. R29 is not particularly limited as long as R29 is a group represented by ═CH—R30 (R30 is one of a hydrogen group and an alkyl group). It is to be noted that the type and the carbon number of the foregoing alkyl group are similar to those of R21 and R22. Specific examples of the methylene ethylene carbonate-based compounds include methylene ethylene carbonate (4-methylene-1,3-dioxolane-2-one), 4,4-dimethyl-5-methylene-1,3-dioxolane-2-one, and 4,4-diethyl-5-methylene-1,3-dioxolane-2-one. The methylene ethylene carbonate-based compound may be the compound having one methylene group as represented by Formula (10), or may be a compound having two methylene groups.

It is to be noted that the unsaturated cyclic ester carbonate may be the compounds represented by Formula (7) to Formula (9), or may be catechol carbonate having a benzene ring.

Further, the solvent preferably contains one, or two or more of a halogenated ester carbonates represented by Formula (10) and Formula (11) described below. One reason for this is that a stable protective film is formed on mainly the surface of the anode 22 at the time of charge and discharge, and therefore a decomposition reaction of the electrolytic solution is suppressed. The halogenated ester carbonate represented by Formula (10) is a cyclic ester carbonate having one, or two or more halogens as constituent elements (halogenated cyclic ester carbonate). Meanwhile, the halogenated ester carbonate represented by Formula (11) is a chain ester carbonate having one, or two or more halogens as constituent elements (halogenated chain ester carbonate). R30 to R33 may be the same type of group, or may be groups different from each other. Alternatively, some of R30 to R33 may be the same type of group. The same is applied to R34 to R39. Although the content of the halogenated ester carbonate in the solvent is not particularly limited, the content thereof is, for example, from 0.01 wt % to 50 wt % both inclusive. However, specific examples of the halogenated ester carbonate are not limited to the compounds described below, and other compounds corresponding to Formula (10) and Formula (11) may be used.

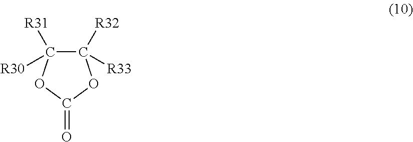

In Formula (10), each of R30 to R33 is one of a hydrogen group, a halogen group, an alkyl group, and a halogenated alkyl group. One or more of R30 to R33 each are one of a halogen group and a halogenated alkyl group.

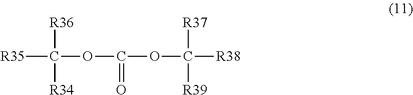

In Formula (11), each of R34 to R39 is one of a hydrogen group, a halogen group, an alkyl group, and a halogenated alkyl group. One or more of R34 to R39 each are a halogen group or a halogenated alkyl group.

Although halogen type is not particularly limited, specially, fluorine (—F), chlorine (—Cl), or bromine (Br) is preferable, and fluorine is more preferable since thereby a higher effect is obtained compared to other halogens. However, the number of halogens is more preferably two than one, and further may be three or more. One reason for this is that, since thereby an ability of forming a protective film is improved and a more rigid and stable protective film is formed, a decomposition reaction of the electrolytic solution is thereby more suppressed.

Examples of the halogenated cyclic ester carbonate include compounds represented by Formula (10-1) to Formula (10-21) described below. The halogenated cyclic ester carbonate includes a geometric isomer. Specially, 4-fluoro-1,3-dioxolane-2-one represented by Formula (10-1) or 4,5-difluoro-1,3-dioxolane-2-one represented by Formula (10-3) is preferable, and the latter is more preferable. Further, as 4,5-difluoro-1,3-dioxolane-2-one, a trans isomer is more preferable than a cis isomer, since the trans isomer is easily available and provides a high effect. Examples of the halogenated chain ester carbonate include fluoromethyl methyl carbonate, bis(fluoromethyl) carbonate, and difluoromethyl methyl carbonate.

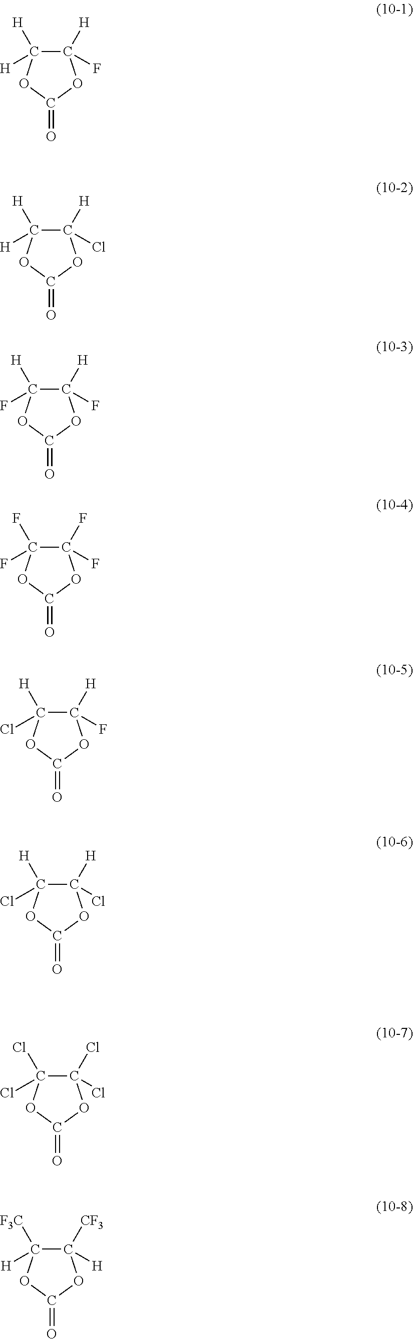

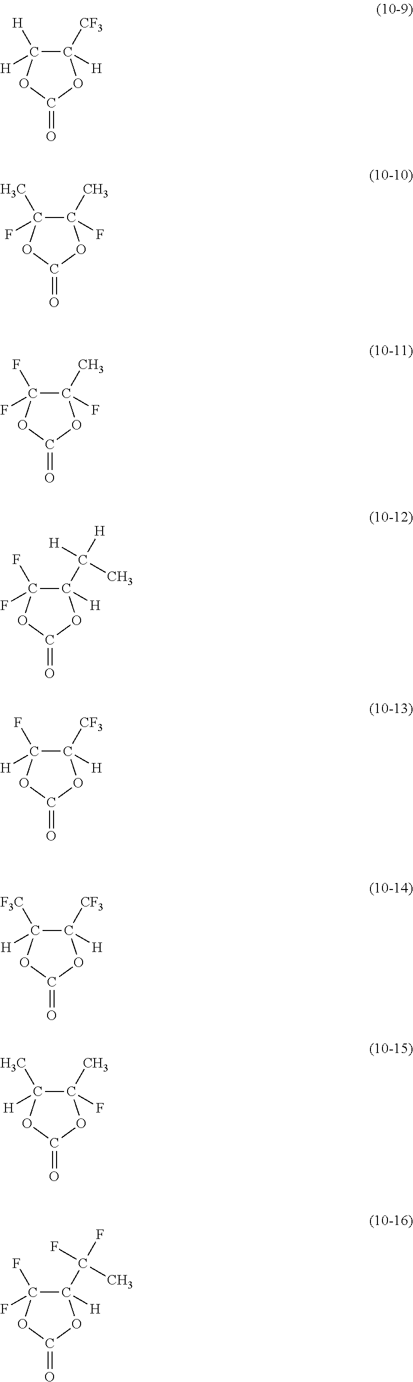

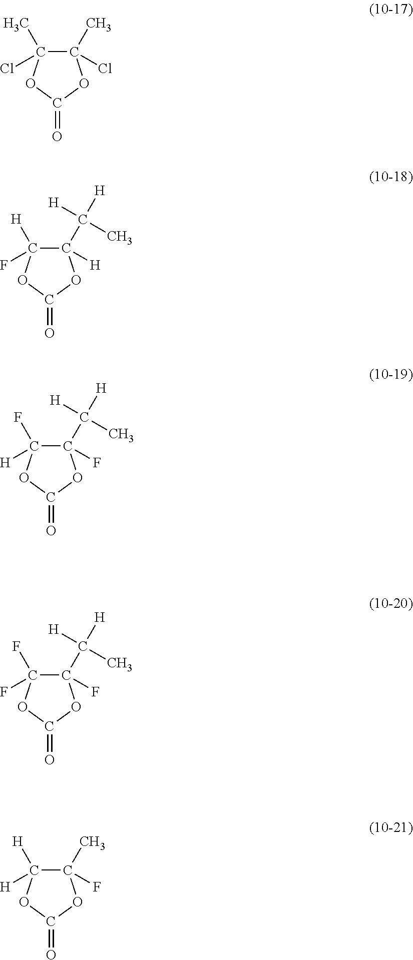

Further, the solvent preferably contains sultone (cyclic sulfonic ester), since thereby the chemical stability of the electrolytic solution is more improved. Examples of sultone include propane sultone and propene sultone. Although the sultone content in the solvent is not particularly limited, for example, the sultone content is from 0.5 wt % to 5 wt % both inclusive. Specific examples of sultone are not limited to the foregoing compounds, and may be other compounds.

Further, the solvent preferably contains an acid anhydride since the chemical stability of the electrolytic solution is thereby further improved. Examples of the acid anhydrides include a carboxylic anhydride, a disulfonic anhydride, and a carboxylic acid sulfonic acid anhydride. Examples of the carboxylic anhydride include a succinic anhydride, a glutaric anhydride, and a maleic anhydride. Examples of the disulfonic anhydride include an ethane disulfonic anhydride and a propane disulfonic anhydride. Examples of the carboxylic acid sulfonic acid anhydride include a sulfobenzoic anhydride, a sulfopropionic anhydride, and a sulfobutyric anhydride. Although the content of the acid anhydride in the solvent is not particularly limited, for example, the content thereof is from 0.5 wt % to 5 wt % both inclusive. However, specific examples of the acid anhydrides are not limited to the foregoing compounds, and other compound may be used.

### [Electrolyte Salt]

The electrolyte salt may contain, for example, one, or two or more of salts such as a lithium salt. However, the electrolyte salt may contain, for example, a salt other than the lithium salt (for example, a light metal salt other than the lithium salt).

Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior storage characteristics, and the like are obtained. However, specific examples of the lithium salt are not limited to the foregoing compounds, and may be other compounds.

Specially, one or more of lithium hexafluorophosphate, lithium tetrafluoroborate, lithium perchlorate, and lithium hexafluoroarsenate are preferable, and lithium hexafluorophosphate is more preferable, since the internal resistance is thereby lowered, and therefore a higher effect is obtained.

In particular, the electrolyte salt preferably contains one, or two or more of compounds represented by Formula (12) to Formula (14) described below, since thereby a higher effect is obtained. It is to be noted that R41 and R43 may be the same type of group, or may be groups different from each other. The same is applied to R51 to R53, R61, and R62. However, specific examples of the compounds represented by Formula (12) to Formula (14) are not limited to the after-mentioned compounds, and other compounds corresponding to Formula (12) to Formula (14) may be used.

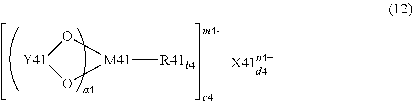

In Formula (12), X41 is a Group 1 element, a Group 2 element in the long period periodic table, or aluminum. M41 is one of a transition metal, a Group 13 element, a Group 14 element, and a Group 15 element in the long period periodic table. R41 is a halogen group. Y41 is one of —C(═O)—R42-C(═O)—, —C(═O)—CR432-, and —C(═O)—C(═O)—. R42 is one of an alkylene group, a halogenated alkylene group, an arylene group, and a halogenated arylene group. R43 is one of an alkyl group, a halogenated alkyl group, an aryl group, and a halogenated aryl group. a4 is one of integer numbers 1 to 4 both inclusive. b4 is one of integer numbers 0, 2, and 4. Each of c4, d4, m4, and n4 is one of integer numbers 1 to 3 both inclusive.

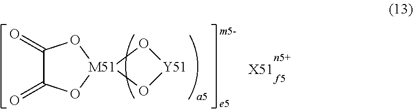

In Formula (13), X51 is one of a Group 1 element and a Group 2 element in the long period periodic table. M51 is one of a transition metal, a Group 13 element, a Group 14 element, and a Group 15 element in the long period periodic table. Y51 is one of —C(═O)—(CR51₂)_{b5}—C(═O)—, —R53₂C—(CR52₂)_{c5}—C(═O)—, —R53₂C—(CR52₂)_{c5}—CR53₂—, —R53₂C—(CR52₂)_{c5}—S(═O)₂—, —S(═O)₂—(CR52₂)_{d5}—S(═O)₂—, and —C(═O)—(CR52₂)_{d5}—S(═O)₂—. Each of R51 and R53 is one of a hydrogen group, an alkyl group, a halogen group, and a halogenated alkyl group. One or more of R51 and R53 each are the halogen group or the halogenated alkyl group. R52 is one of a hydrogen group, an alkyl group, a halogen group, and a halogenated alkyl group. Each of a5, e5, and n5 is one of integer numbers 1 and 2. Each of b5 and d5 is one of integer numbers 1 to 4 both inclusive. c5 is one of integer numbers 0 to 4 both inclusive. Each of f5 and m5 is one of integer numbers 1 to 3 both inclusive.

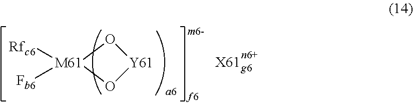

In Formula (14), X61 is one of a Group 1 element and a Group 2 element in the long period periodic table. M61 is one of a transition metal, a Group 13 element, a Group 14 element, and a Group 15 element in the long period periodic table. Rf is one of a fluorinated alkyl group with carbon number from 1 to 10 both inclusive and a fluorinated aryl group with carbon number from 1 to 10 both inclusive. Y61 is one of —C(═O)—(CR61₂)_{d6}—C(═O)—, —R62₂C—(CR61₂)_{d6}—C(═O)—, —R62₂C—(CR61₂)_{d6}—CR62₂—, —R62₂C—(CR61₂)_{d6}—S(═O)₂—, —S(═O)₂—(CR61₂)ₑ₆—S(═O)₂—, and —C(═O)—(CR61₂)ₑ₆—S(═O)₂—. R61 is one of a hydrogen group, an alkyl group, a halogen group, and a halogenated alkyl group. R62 is one of a hydrogen group, an alkyl group, a halogen group, and a halogenated alkyl group, and one or more thereof each are a halogen group or a halogenated alkyl group. Each of a6, f6, and n6 is one of integer numbers 1 and 2. Each of b6, c6, and e6 is one of integer numbers 1 to 4 both inclusive. d6 is one of integer numbers 0 to 4 both inclusive. Each of g6 and m6 is one of integer numbers 1 to 3 both inclusive.

It is to be noted that Group 1 elements include hydrogen, lithium, sodium, potassium, rubidium, cesium, and francium. Group 2 elements include beryllium, magnesium, calcium, strontium, barium, and radium. Group 13 elements include boron, aluminum, gallium, indium, and thallium. Group 14 elements include carbon, silicon, germanium, tin, and lead. Group 15 elements include nitrogen, phosphorus, arsenic, antimony, and bismuth.

Examples of the compound represented by Formula (12) include compounds represented by Formula (12-1) to Formula (12-6). Examples of the compound represented by Formula (13) include compounds represented by Formula (13-1) to Formula (13-8). Examples of the compound represented by Formula (14) include a compound represented by Formula (14-1).

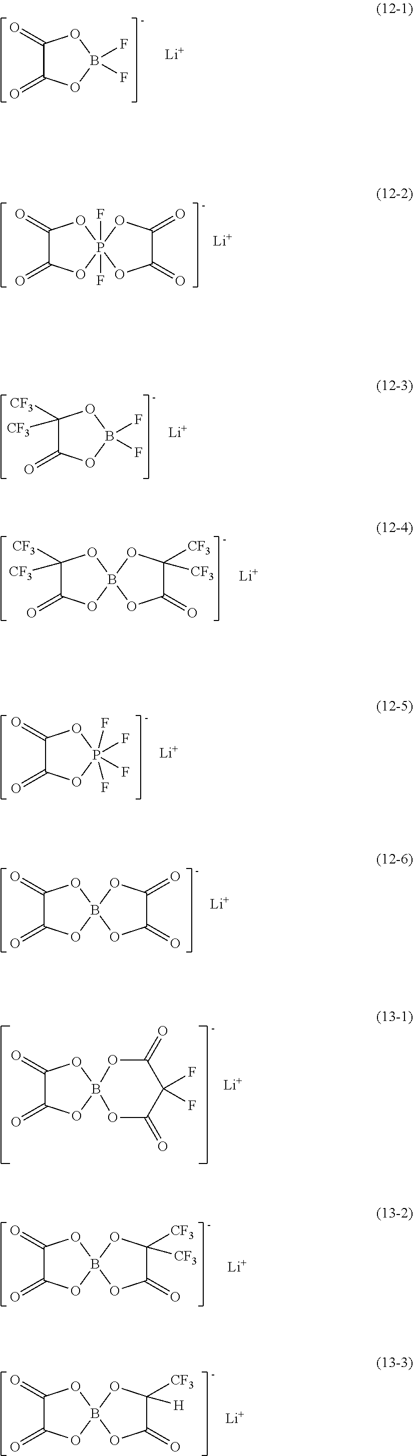

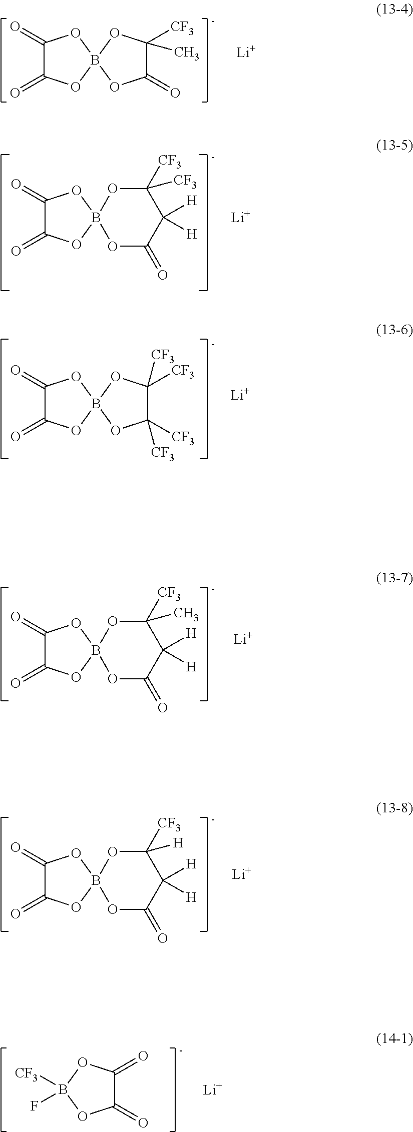

Further, the electrolyte salt preferably contains one, or two or more of compounds represented by Formula (15) to Formula (17) described below, since thereby a higher effect is obtained. m and n may be the same value or values different from each other. The same is applied to p, q, and r. However, specific examples of the compounds represented by Formula (15) to Formula (17) are not limited to compounds described below and other compounds corresponding to Formula (15) to Formula (17) may be used.

LiN(CₘF2ₘ+1SO₂)(CₙF₂ₙ₊₁SO₂) (15)

In Formula (15), each of m and n is an integer number equal to or greater than 1.

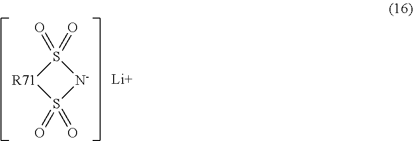

In Formula (16), R71 is a straight-chain or branched perfluoro alkylene group with carbon number from 2 to 4 both inclusive.

LiC(CₚF₂ₚ₊₁SO₂)(C_{q}F_{2q+1}SO₂)(CᵣF₂ᵣ₊₁SO₂) (17)

In Formula (17), each of p, q, and r is an integer number equal to or greater than 1.

The compound represented by Formula (15) is a chain imide compound. Examples thereof include lithium bis(trifluoromethanesulfonyl)imide (LiN(CF₃SO₂)₂), lithium bis(pentafluoroethanesulfonyl)imide (LiN(C₂F₅SO₂)₂), lithium (trifluoromethanesulfonyl)(pentafluoroethanesulfonyl)imide (LiN(CF₃SO₂)(C₂F₅SO₂)), lithium (trifluoromethanesulfonyl)(heptafluoropropanesulfonyl)imide LiN(CF₃SO₂)(C₃F₇SO₂)), and lithium (trifluoromethanesulfonyl)(nonafluorobutanesulfonyl)imide (LiN(CF₃SO₂)(C₄F₉SO₂)).

The compound represented by Formula (16) is a cyclic imide compound. Examples thereof include compounds represented by Formula (16-1) to Formula (16-4).

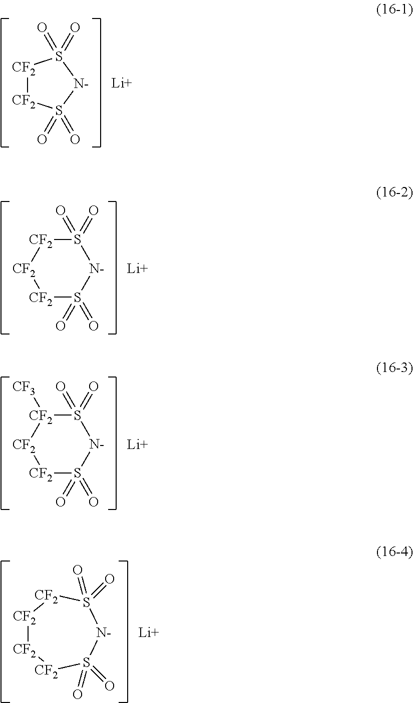

The compound represented by Formula (17) is a chain methyde compound. Examples thereof include lithium tris(trifluoromethanesulfonyl)methyde (LiC(CF₃SO₂)₃).

Although the content of the electrolyte salt is not particularly limited, specially, the content thereof is preferably from 0.3 mol/kg to 3.0 mol/kg both inclusive with respect to the solvent, since thereby high ion conductivity is obtained.

### [Operation of Secondary Battery]

In the secondary battery, for example, at the time of charge, lithium ions extracted from the cathode 21 are inserted in the anode 22 through the electrolytic solution. Further, at the time of discharge, lithium ions extracted from the anode 22 are inserted in the cathode 21 through the electrolytic solution.

### [Method of Manufacturing Secondary Battery]

The secondary battery is manufactured, for example, by the following procedure.

First, the cathode 21 is formed. A cathode active material is mixed with a cathode binder, a cathode electric conductor, and/or the like as necessary to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded by using a roll pressing machine and/or the like while being heated as necessary. In this case, compression-molding may be repeated several times.

Further, the anode 22 is formed by a procedure similar to that of the cathode 21 described above. An anode active material is mixed with an anode binder, an anode electric conductor, and/or the like as necessary to prepare an anode mixture, which is subsequently dispersed in an organic solvent or the like to form paste anode mixture slurry. Subsequently, both surfaces of the anode current collector 22A are coated with the anode mixture slurry, which is dried to form the anode active material layer 22B. After that, the anode active material layer 22B is compression-molded as necessary.

Further, after an electrolyte salt is dispersed in a solvent, a cyano cyclic ester carbonate is added thereto to prepare an electrolytic solution.

Finally, the secondary battery is assembled by using the cathode 21 and the anode 22. First, the cathode lead 25 is attached to the cathode current collector 21A by using a welding method and/or the like, and the anode lead 26 is attached to the anode current collector 22A by using a welding method and/or the like. Subsequently, the cathode 21 and the anode 22 are layered with the separator 23 in between and are spirally wound, and thereby the spirally wound electrode body 20 is formed. After that, the center pin 24 is inserted in the center of the spirally wound electrode body 20. Subsequently, the spirally wound electrode body 20 is sandwiched between the pair of insulating plates 12 and 13, and is contained in the battery can 11. In this case, the end tip of the cathode lead 25 is attached to the safety valve mechanism 15 by using a welding method and/or the like, and the end tip of the anode lead 26 is attached to the battery can 11 by using a welding method and/or the like. Subsequently, the electrolytic solution is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

### [Function and Effect of Secondary Battery]

According to the cylindrical type secondary battery, the electrolytic solution contains the cyano cyclic ester carbonate. In this case, compared to in the case where the electrolytic solution does not contain the cyano cyclic ester carbonate or in the case where the electrolytic solution contains other compound, the chemical stability of the electrolytic solution is specifically improved, and therefore a decomposition reaction of the electrolytic solution is significantly suppressed. Examples of “other compound” include a compound represented by Formula (18) described below. The compound represented by Formula (18) does not have a halogen group and/or the like although the total number of cyano groups is 1. Therefore, even if the secondary battery is charged, discharged, or stored in a severe environment such as a high temperature environment, the electrolytic solution is less likely to be decomposed. Accordingly, superior battery characteristics are obtainable. In particular, in the case where the content of the cyano cyclic ester carbonate in the electrolytic solution is from 0.01 wt % to 20 wt % both inclusive, higher effects are obtainable.

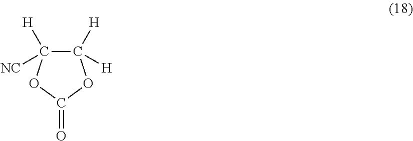

### [1-2. Lithium Ion Secondary Battery (Laminated Film Type)]

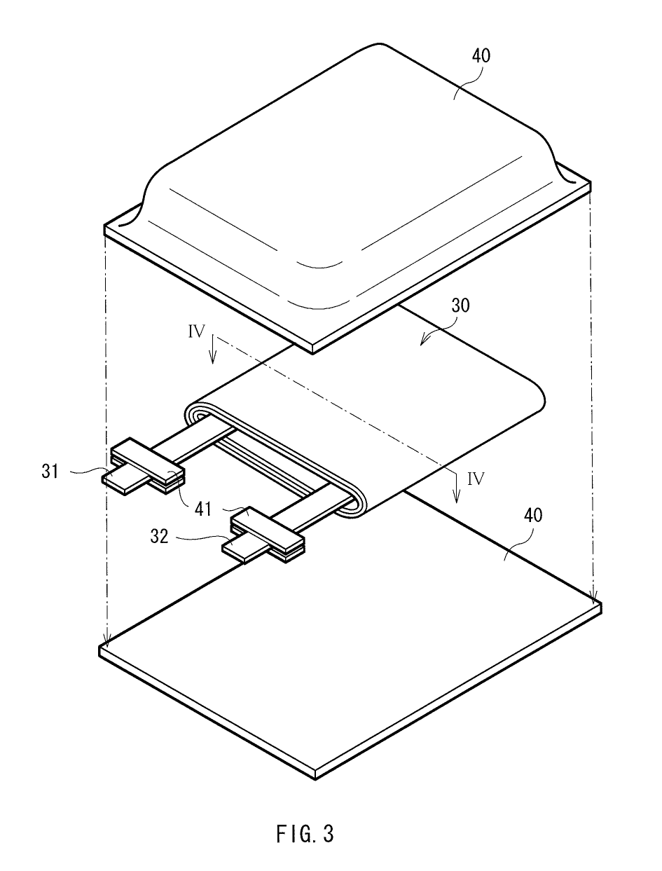

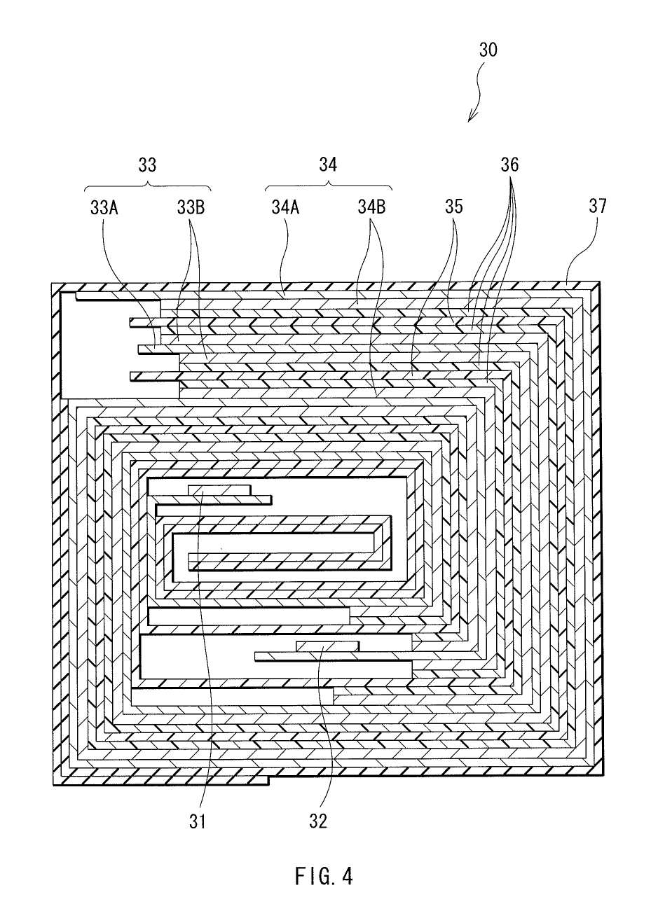

FIG. 3 illustrates an exploded perspective configuration of another secondary battery according to an embodiment of the present technology. FIG. 4 illustrates an enlarged cross-section taken along a line IV-IV of a spirally wound electrode body 30 illustrated in FIG. 3. In the following description, the elements of the cylindrical type secondary battery described above will be used as necessary.

### [Whole Configuration of Secondary Battery]

The secondary battery is what we call a laminated film type lithium ion secondary battery. In the secondary battery, the spirally wound electrode body 30 is contained in a film outer package member 40. In the spirally wound electrode body 30, a cathode 33 and an anode 34 are layered with a separator 35 and an electrolyte layer 36 in between and are spirally wound. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 are, for example, led out from inside to outside of the outer package member 40 in the same direction. The cathode lead 31 is made of, for example, a conductive material such as aluminum, and the anode lead 32 is made of, for example, a conducive material such as copper, nickel, and stainless steel. These conductive materials are in the shape of, for example, a thin plate or mesh.

The outer package member 40 is a laminated film in which, for example, a fusion bonding layer, a metal layer, and a surface protective layer are laminated in this order. In the laminated film, for example, the respective outer edges of the fusion bonding layers of two films are bonded to each other by fusion bonding, an adhesive, or the like so that the fusion bonding layers and the spirally wound electrode body 30 are opposed to each other. Examples of the fusion bonding layer include a film made of polyethylene, polypropylene, or the like. Examples of the metal layer include an aluminum foil. Examples of the surface protective layer include a film made of nylon, polyethylene terephthalate, or the like.

Specially, as the outer package member 40, an aluminum laminated film in which a polyethylene film, an aluminum foil, and a nylon film are laminated in this order is preferable. However, the outer package member 40 may be made of a laminated film having other laminated structure, a polymer film such as polypropylene, or a metal film.

An adhesive film 41 to protect from entering of outside air is inserted between the outer package member 40, and the cathode lead 31 and the anode lead 32. The adhesive film 41 is made of a material having adhesion characteristics with respect to the cathode lead 31 and the anode lead 32. Examples of such a material include a polyolefin resin such as polyethylene, polypropylene, modified polyethylene, and modified polypropylene.

In the cathode 33, for example, a cathode active material layer 33B is provided on both surfaces of a cathode current collector 33A. In the anode 34, for example, an anode active material layer 34B is provided on both surfaces of an anode current collector 34A. The configurations of the cathode current collector 33A, the cathode active material layer 33B, the anode current collector 34A, and the anode active material layer 34B are respectively similar to the configurations of the cathode current collector 21A, the cathode active material layer 21B, the anode current collector 22A, and the anode active material layer 22B. Further, the configuration of the separator 35 is similar to the configuration of the separator 23.

In the electrolyte layer 36, an electrolytic solution is held by a polymer compound. The electrolyte layer 36 is what we call a gel electrolyte, since thereby high ion conductivity (for example, 1 mS/cm or more at room temperature) is obtained and liquid leakage of the electrolytic solution is prevented. The electrolyte layer 36 may contain other material such as an additive as necessary.

Examples of the polymer compound include one, or two or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate, and a copolymer of vinylidene fluoride and hexafluoropropylene. Specially, polyvinylidene fluoride or the copolymer of vinylidene fluoride and hexafluoropropylene is preferable, and polyvinylidene fluoride is more preferable, since such a polymer compound is electrochemically stable.

The composition of the electrolytic solution is similar to the composition of the electrolytic solution of the cylindrical type secondary battery. The electrolytic solution contains cyano cyclic ester. However, in the electrolyte layer 36 as a gel electrolyte, the solvent of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

Instead of the gel electrolyte layer 36, the electrolytic solution may be used as it is. In this case, the separator 35 is impregnated with the electrolytic solution.

### [Operation of Secondary Battery]

In the secondary battery, for example, at the time of charge, lithium ions extracted from the cathode 33 are inserted in the anode 34 through the electrolyte layer 36. Meanwhile, at the time of discharge, lithium ions extracted from the anode 34 are inserted in the cathode 33 through the electrolyte layer 36.

### [Method of Manufacturing Secondary Battery]

The secondary battery including the gel electrolyte layer 36 is manufactured, for example, by the following three types of procedures.

In the first procedure, the cathode 33 and the anode 34 are formed by a formation procedure similar to that of the cathode 21 and the anode 22. In this case, the cathode 33 is formed by forming the cathode active material layer 33B on both surfaces of the cathode current collector 33A, and the anode 34 is formed by foaming the anode active material layer 34B on both surfaces of the anode current collector 34A. Subsequently, a precursor solution containing an electrolytic solution, a polymer compound, and a solvent such as an organic solvent is prepared. After that, the cathode 33 and the anode 34 are coated with the precursor solution to form the gel electrolyte layer 36. Subsequently, the cathode lead 31 is attached to the cathode current collector 33A by using a welding method and/or the like and the anode lead 32 is attached to the anode current collector 34A by using a welding method and/or the like. Subsequently, the cathode 33 and the anode 34 provided with the electrolyte layer 36 are layered with the separator 35 in between and are spirally wound to form the spirally wound electrode body 30. After that, the protective tape 37 is adhered to the outermost periphery thereof. Subsequently, after the spirally wound electrode body 30 is sandwiched between two pieces of film-like outer package members 40, the outer edges of the outer package members 40 are bonded by a thermal fusion bonding method and/or the like to enclose the spirally wound electrode body 30 into the outer package members 40. In this case, the adhesive films 41 are inserted between the cathode lead 31 and the anode lead 32, and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to form a spirally wound body as a precursor of the spirally wound electrode body 30. After that, the protective tape 37 is adhered to the outermost periphery thereof. Subsequently, after the spirally wound body is sandwiched between two pieces of the film-like outer package members 40, the outermost peripheries except for one side are bonded by using a thermal fusion bonding method and/or the like to obtain a pouched state, and the spirally wound body is contained in the pouch-like outer package member 40. Subsequently, a composition for electrolyte containing an electrolytic solution, a monomer as a raw material for the polymer compound, a polymerization initiator, and other materials such as a polymerization inhibitor as necessary is prepared, which is injected into the pouch-like outer package member 40. After that, the outer package member 40 is hermetically sealed by using a thermal fusion bonding method and/or the like. Subsequently, the monomer is thermally polymerized. Thereby, a polymer compound is formed, and therefore the gel electrolyte layer 36 is formed.

In the third procedure, the spirally wound body is formed and contained in the pouch-like outer package member 40 in a manner similar to that of the foregoing second procedure, except that the separator 35 with both surfaces coated with a polymer compound is used. Examples of the polymer compound with which the separator 35 is coated include a polymer (a homopolymer, a copolymer, or a multicomponent copolymer) containing vinylidene fluoride as a component. Specific examples thereof include polyvinylidene fluoride, a binary copolymer containing vinylidene fluoride and hexafluoropropylene as components, and a ternary copolymer containing vinylidene fluoride, hexafluoropropylene, and chlorotrifluoroethylene as components. In addition to the polymer containing vinylidene fluoride as a component, other one, or two or more polymer compounds may be used. Subsequently, an electrolytic solution is prepared and injected into the outer package member 40. After that, the opening of the outer package member 40 is hermetically sealed by a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly the polymer compound is gelated to faun the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, sufficient adhesion characteristics are obtained between the cathode 33, the anode 34, and the separator 35, and the electrolyte layer 36.

### [Function and Effect of Secondary Battery]

According to the laminated film type secondary battery, the electrolytic solution of the electrolyte layer 36 contains the cyano cyclic ester carbonate. Therefore, for a reason similar to that of the cylindrical type secondary battery, superior battery characteristics are obtainable. Other functions and other effects are similar to those of the cylindrical type secondary battery.

### [1-3. Lithium Metal Secondary Battery (Cylindrical Type and Laminated Film Type)]

A secondary battery hereinafter described is a lithium secondary battery (lithium ion secondary battery) in which the capacity of the anode 22 is obtained by precipitation and dissolution of lithium (lithium metal) as an electrode reactant. The secondary battery has a configuration similar to that of the foregoing lithium ion secondary battery (cylindrical type), except that the anode active material layer 22B is formed of lithium metal, and is manufactured by a procedure similar to that of the foregoing lithium ion secondary battery (cylindrical type).

In the secondary battery, lithium metal is used as an anode active material, and thereby higher energy density is obtainable. The anode active material layer 22B may exist at the time of assembling, or the anode active material layer 22B does not necessarily exist at the time of assembling and may be formed of lithium metal precipitated at the time of charge. Further, the anode active material layer 22B may be used as a current collector as well, and the anode current collector 22A may be omitted.

In the secondary battery, for example, at the time of charge, lithium ions extracted from the cathode 21 are precipitated as lithium metal on the surface of the anode current collector 22A through the electrolytic solution. Meanwhile, for example, at the time of discharge, lithium metal is eluted in the electrolytic solution as lithium ions from the anode active material layer 22B, and is inserted in the cathode 21 through the electrolytic solution.

According to the lithium metal secondary battery, the electrolytic solution contains the cyano cyclic ester carbonate. Therefore, for a reason similar to that of the lithium ion secondary battery described above, superior battery characteristics are obtainable. Other functions and other effects are similar to those of the cylindrical type secondary battery. It is to be noted that the foregoing lithium metal secondary battery is not limited to the cylindrical type secondary battery, and may be a laminated film type secondary battery. In this case, a similar effect is also obtainable.

### [2. Applications of Secondary Battery]

Next, a description will be given of application examples of the foregoing secondary battery.

Applications of the secondary battery are not particularly limited as long as the secondary battery is used for a machine, a device, an instrument, an apparatus, a system (collective entity of a plurality of devices and the like), or the like that is allowed to use the secondary battery as a driving electric power source, an electric power storage source for electric power storage, or the like. In the case where the secondary battery is used as an electric power source, the secondary battery may be used as a main electric power source (electric power source used preferentially), or an auxiliary electric power source (electric power source used instead of a main electric power source or used being switched from the main electric power source). In the latter case, the main electric power source type is not limited to the secondary battery.

Examples of applications of the secondary battery include mobile electronic devices such as a video camcoder, a digital still camera, a mobile phone, a notebook personal computer, a cordless phone, a headphone stereo, a portable radio, a portable television, and a personal digital assistant. Further examples thereof include a mobile lifestyle electric appliance such as an electric shaver; a memory device such as a backup electric power source and a memory card; an electric power tool such as an electric drill and an electric saw; a battery pack used as an electric power source of a notebook personal computer or the like; a medical electronic device such as a pacemaker and a hearing aid; an electric vehicle such as an electric automobile (including a hybrid automobile); and an electric power storage system such as a home battery system for storing electric power for emergency or the like. It is needless to say that an application other than the foregoing applications may be adopted.

Specially, the secondary battery is effectively applicable to the battery pack, the electric vehicle, the electric power storage system, the electric power tool, the electronic device, or the like. In these applications, since superior battery characteristics are demanded, the characteristics are allowed to be effectively improved by using the secondary battery according to the embodiments of the present technology. It is to be noted that the battery pack is an electric power source using a secondary battery, and is what we call an assembled battery or the like. The electric vehicle is a vehicle that works (runs) by using a secondary battery as a driving electric power source. As described above, an automobile including a drive source other than a secondary battery (hybrid automobile or the like) may be included. The electric power storage system is a system using a secondary battery as an electric power storage source. For example, in a home electric power storage system, electric power is stored in the secondary battery as an electric power storage source, and the electric power is consumed as necessary. Thereby, home electric products and the like become usable. The electric power tool is a tool in which a movable section (for example, a drill or the like) is moved by using a secondary battery as a driving electric power source. The electronic device is a device executing various functions by using a secondary battery as a driving electric power source (electric power supply source).

A description will be specifically given of some application examples of the secondary battery. The configurations of the respective application examples explained below are merely examples, and may be changed as appropriate.

### [2-1. Battery Pack]

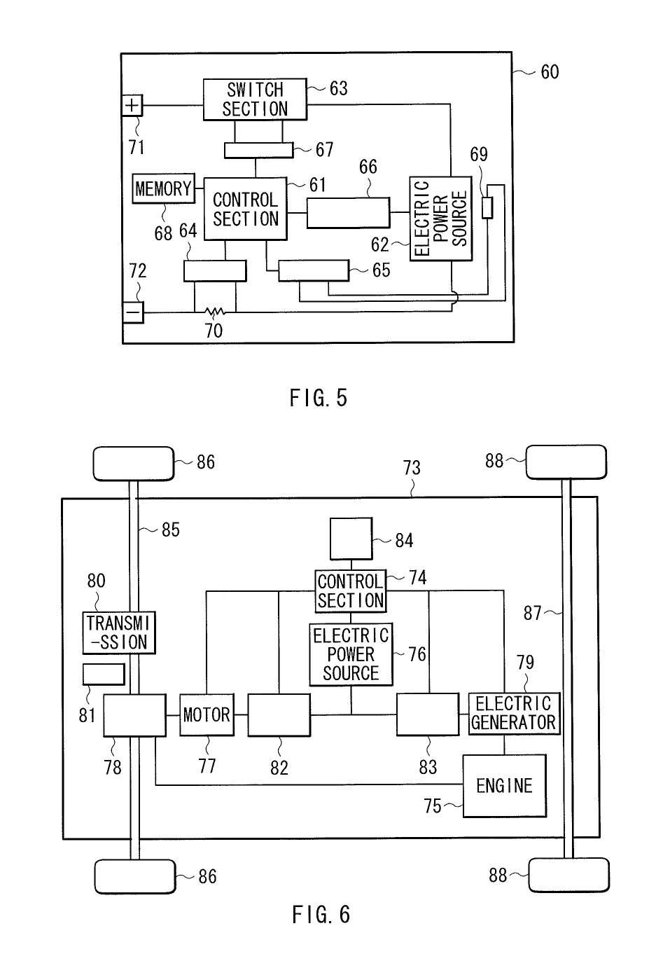

FIG. 5 illustrates a block configuration of a battery pack. For example, as illustrated in FIG. 5, the battery pack includes a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material and/or the like.

The control section 61 controls operation of the whole battery pack (including a usage state of the electric power source 62), and includes, for example, a central processing unit (CPU) and/or the like. The electric power source 62 includes one, or two or more secondary batteries (not illustrated). The electric power source 62 is, for example, an assembled battery including two or more secondary batteries. Connection type thereof may be series-connected type, may be parallel-connected type, or a mixed type thereof. As an example, the electric power source 62 includes six secondary batteries connected in a manner of dual-parallel and three-series.

The switch section 63 switches the usage state of the electric power source 62 (whether or not the electric power source 62 is connectable to an external device) according to an instruction of the control section 61. The switch section 63 includes, for example, a charge control switch, a discharge control switch, a charging diode, a discharging diode, and the like (not illustrated). The charge control switch and the discharge control switch are, for example, semiconductor switches such as a field-effect transistor (MOSFET) using metal oxide semiconductor.

The current measurement section 64 measures a current by using the current detection resistance 70, and outputs the measurement result to the control section 61. The temperature detection section 65 measures temperature by using the temperature detection device 69, and outputs the measurement result to the control section 61. The temperature measurement result is used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion (A/D conversion) on the measured voltage, and supplies the resultant to the control section 61.

The switch control section 67 controls operation of the switch section 63 according to signals inputted from the current measurement section 64 and the voltage measurement section 66.

The switch control section 67 executes control so that a charge current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charge current.

The switch control section 67 executes control so that a discharge current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. For example, in the case where a large current flows at the time of discharge, the switch control section 67 blocks the discharge current.

It is to be noted that, in the secondary battery, for example, the overcharge detection voltage is 4.20 V±0.05 V, and the over-discharge detection voltage is 2.4 V±0.1 V.

The memory 68 is, for example, an EEPROM as a nonvolatile memory or the like. The memory 68 stores, for example, numerical values calculated by the control section 61 and information of the secondary battery measured in a manufacturing step (for example, an internal resistance in the initial state or the like). It is to be noted that, in the case where the memory 68 stores a full charge capacity of the secondary battery, the control section 10 is allowed to comprehend information such as a remaining capacity.

The temperature detection device 69 measures temperature of the electric power source 62, and outputs the measurement result to the control section 61. The temperature detection device 69 is, for example, a thermistor or the like.

The cathode terminal 71 and the anode terminal 72 are terminals connected to an external device (for example, a notebook personal computer or the like) driven by using the battery pack or an external device (for example, a battery charger or the like) used for charging the battery pack. The electric power source 62 is charged and discharged through the cathode terminal 71 and the anode terminal 72.

### [2-2. Electric Vehicle]

FIG. 6 illustrates a block configuration of a hybrid automobile as an example of electric vehicles. For example, as illustrated in FIG. 6, the electric vehicle includes a control section 74, an engine 75, an electric power source 76, a driving motor 77, a differential 78, an electric generator 79, a transmission 80, a clutch 81, inverters 82 and 83, and various sensors 84 in a housing 73 made of a metal. In addition, the electric vehicle includes, for example, a front drive axis 85 and a front tire 86 that are connected to the differential 78 and the transmission 80, a rear drive axis 87, and a rear tire 88.

The electric vehicle is runnable by using one of the engine 75 and the motor 77 as a drive source. The engine 75 is a main power source, and is, for example, a gasoline engine. In the case where the engine 75 is used as a power source, drive power (torque) of the engine 75 is transferred to the front tire 86 or the rear tire 88 through the differential 78, the transmission 80, and the clutch 81 as drive sections, for example. The torque of the engine 75 is also transferred to the electric generator 79. Due to the torque, the electric generator 79 generates alternating-current electric power. The alternating-current electric power is converted to direct-current electric power through the inverter 83, and the converted power is stored in the electric power source 76. Meanwhile, in the case where the motor 77 as a conversion section is used as a power source, electric power (direct-current electric power) supplied from the electric power source 76 is converted to alternating-current electric power through the inverter 82. The motor 77 is driven by the alternating-current electric power. Drive power (torque) obtained by converting the electric power by the motor 77 is transferred to the front tire 86 or the rear tire 88 through the differential 78, the transmission 80, and the clutch 81 as the drive sections, for example.

It is to be noted that, alternatively, the following mechanism may be adopted. In the mechanism, in the case where speed of the electric vehicle is reduced by an unillustrated brake mechanism, the resistance at the time of speed reduction is transferred to the motor 77 as torque, and the motor 77 generates alternating-current electric power by the torque. It is preferable that the alternating-current electric power be converted to direct-current electric power through the inverter 82, and the direct-current regenerative electric power be stored in the electric power source 76.

The control section 74 controls operation of the whole electric vehicle, and, for example, includes a CPU and/or the like. The electric power source 76 includes one, or two or more secondary batteries (not illustrated). Alternatively, the electric power source 76 may be connected to an external electric power source, and electric power may be stored by receiving the electric power from the external electric power source. The various sensors 84 are used, for example, for controlling the number of revolutions of the engine 75 or for controlling opening level of an unillustrated throttle valve (throttle opening level). The various sensors 84 include, for example, a speed sensor, an acceleration sensor, an engine frequency sensor, and/or the like.

The description has been hereinbefore given of the hybrid automobile as an electric vehicle. However, examples of the electric vehicles may include a vehicle (electric automobile) working by using only the electric power source 76 and the motor 77 without using the engine 75.

### [2-3. Electric Power Storage System]

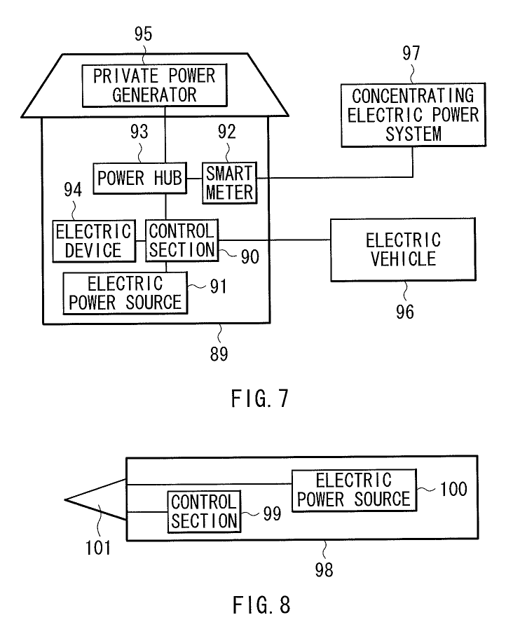

FIG. 7 illustrates a block configuration of an electric power storage system. For example, as illustrated in FIG. 7, the electric power storage system includes a control section 90, an electric power source 91, a smart meter 92, and a power hub 93 inside a house 89 such as a general residence and a commercial building.

In this case, the electric power source 91 is connected to, for example, an electric device 94 arranged inside the house 89, and is connectable to an electric vehicle 96 parked outside the house 89. Further, for example, the electric power source 91 is connected to a private power generator 95 arranged inside the house 89 through the power hub 93, and is connectable to an external concentrating electric power system 97 thorough the smart meter 92 and the power hub 93.

It is to be noted that the electric device 94 includes, for example, one, or two or more home electric appliances such as a refrigerator, an air conditioner, a television, and a water heater. The private power generator 95 is one, or two or more of a solar power generator, a wind-power generator, and the like. The electric vehicle 96 is one, or two or more of an electric automobile, an electric motorcycle, a hybrid automobile, and the like. The concentrating electric power system 97 is, for example, one, or two or more of a thermal power plant, an atomic power plant, a hydraulic power plant, a wind-power plant, and the like.

The control section 90 controls operation of the whole electric power storage system (including a usage state of the electric power source 91), and, for example, includes a CPU and/or the like. The electric power source 91 includes one, or two or more secondary batteries (not illustrated). The smart meter 92 is, for example, an electric power meter compatible with a network arranged in the house 89 demanding electric power, and is communicable with an electric power supplier. Accordingly, for example, while the smart meter 92 communicates with external as necessary, the smart meter 92 controls the balance between supply and demand in the house 89 and allows effective and stable energy supply.

In the electric power storage system, for example, electric power is stored in the electric power source 91 from the concentrating electric power system 97 as an external electric power source through the smart meter 92 and the power hub 93, and electric power is stored in the electric power source 91 from the private power generator 95 as an independent electric power source through the power hub 93. As necessary, the electric power stored in the electric power source 91 is supplied to the electric device 94 or the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 by using the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

The foregoing electric power storage system may be arranged for each household (family unit), or may be arranged for a plurality of households (family units).

### [2-4. Electric Power Tool]

FIG. 8 illustrates a block configuration of an electric power tool. For example, as illustrated in FIG. 8, the electric power tool is an electric drill, and includes a control section 99 and an electric power source 100 in a tool body 98 made of a plastic material and/or the like. For example, a drill section 101 as a movable section is attached to the tool body 98 in an operable (rotatable) manner.

The control section 99 controls operation of the whole electric power tool (including a usage state of the electric power source 100), and includes, for example, a CPU and/or the like. The electric power source 100 includes one, or two or more secondary batteries (not illustrated). The control section 99 executes control so that electric power is supplied from the electric power source 100 to the drill section 101 as necessary according to operation of an unillustrated operation switch to operate the drill section 101.

### EXAMPLES

Specific Examples according to the embodiments of the present technology will be described in detail.

### Examples 1-1 to 1-12

The cylindrical type lithium ion secondary batteries illustrated in FIG. 1 and FIG. 2 were fabricated by the following procedure.

In forming the cathode 21, first, lithium carbonate (Li₂CO₃) and cobalt carbonate (CoCO₃) were mixed at a molar ratio of Li₂CO₃:CoCO₃=0.5:1. After that, the mixture was fired in the air (900 deg C. for 5 hours). Thereby, lithium-cobalt composite oxide (LiCoO₂) was obtained. Subsequently, 91 parts by mass of a cathode active material (LiCoO₂), 3 parts by mass of a cathode binder (polyvinylidene fluoride: PVDF), and 6 parts by mass of a cathode electric conductor (graphite) were mixed to obtain a cathode mixture. Subsequently, the cathode mixture was dispersed in an organic solvent (N-methyl-2-pyrrolidone: NMP) to obtain paste cathode mixture slurry. Subsequently, both surfaces of the cathode current collector 21A in the shape of a strip (aluminum foil being 20 μm thick) were coated with the cathode mixture slurry uniformly by using a coating device, which was dried to form the cathode active material layer 21B. Finally, the cathode active material layer 21B was compression-molded by using a roll pressing machine.

In forming the anode 22, first, 90 parts by mass of an anode active material (artificial graphite as a carbon material) and 10 parts by mass of an anode binder (PVDF) were mixed to obtain an anode mixture. Subsequently, the anode mixture was dispersed in an organic solvent (NMP) to obtain paste anode mixture slurry. Subsequently, both surfaces of the anode current collector 22A in the shape of a strip (electrolytic copper foil being 15 μm thick) were coated with the anode mixture slurry uniformly by using a coating device, which was dried to form the anode active material layer 22B. Finally, the anode active material layer 22B was compression-molded by using a roll pressing machine.

In preparing an electrolytic solution, an electrolyte salt (LiPF6) was dissolved in a solvent (ethylene carbonate (EC) and dimethyl carbonate (DMC)). After that, as illustrated in Table 1, as necessary, a cyano cyclic ester carbonate was added thereto. In this case, the composition of the solvent was EC:DMC=50:50 at a weight ratio, and the content of the electrolyte salt with respect to the solvent was 1 mol/kg. For comparison, as necessary, the compound represented by Formula (18) was used.

In assembling the secondary battery, first, the cathode lead 25 made of aluminum was welded to the cathode current collector 21A, and the anode lead 26 made of nickel was welded to the anode current collector 22A. Subsequently, the cathode 21 and the anode 22 were layered with the separator 23 (microporous polypropylene film being 25 μm thick) in between and were spirally wound. After that, the winding end section was fixed by using an adhesive tape to form the spirally wound electrode body 20. Subsequently, the center pin 24 was inserted in the center of the spirally wound electrode body 20. Subsequently, while the spirally wound electrode body 20 was sandwiched between the pair of insulating plates 12 and 13, the spirally wound electrode body 20 was contained in the iron battery can 11 plated with nickel. In this case, one end of the cathode lead 25 was welded to the safety valve mechanism 15, and one end of the anode lead 26 was welded to the battery can 11. Subsequently, the electrolytic solution was injected into the battery can 11 by a depressurization method, and the separator 23 was impregnated with the electrolytic solution. Finally, at the open end of the battery can 11, the battery cover 14, the safety valve mechanism 15, and the PTC device 16 were fixed by being swaged with the gasket 17. The cylindrical type secondary battery was thereby completed. In forming the secondary battery, lithium metal was prevented from being precipitated on the anode 22 at the time of full charge by adjusting the thickness of the cathode active material layer 21B.

As characteristics of the secondary battery, high-temperature cycle characteristics and high-temperature storage characteristics were examined. Results illustrated in Table 1 were obtained.

In examining the high-temperature cycle characteristics, one cycle of charge and discharge was performed on the secondary battery in the ambient temperature environment (23 deg C.) to stabilize the battery state. After that, another one cycle of charge and discharge was performed on the secondary battery in the high-temperature environment (65 deg C.), and a discharge capacity was measured. Subsequently, the secondary battery was repeatedly charged and discharged until the total number of cycles reached 300 in the same environment, and a discharge capacity was measured. From these results, cycle retention ratio (%)=(discharge capacity at the 300th cycle/discharge capacity at the second cycle)×100 was calculated. At the time of charge, constant current and constant voltage charge was performed at a current of 0.2 C until the voltage reached the upper limit voltage of 4.2 V, and further charge was performed at a constant voltage until the current reached 0.05 C. At the time of discharge, constant current discharge was performed at a current of 0.2 C until the voltage reached the final voltage of 2.5 V. “0.2 C” and “0.05 C” are respectively current values at which the battery capacity (theoretical capacity) is fully discharged in 5 hours and 20 hours.

In examining the high-temperature storage characteristics, a secondary battery with its battery state stabilized by a procedure similar to that in the case of examining the high-temperature cycle characteristics was used. One cycle of charge and discharge was performed on the secondary battery in the ambient temperature environment (23 deg C.), and a discharge capacity was measured. Subsequently, the secondary battery in a state of being charged again was stored in a constant temperature bath (80 deg C.) for 10 days. After that, the secondary battery was discharged in the ambient temperature environment (23 deg C.), and a discharge capacity was measured. From these results, storage retention ratio (%)=(discharge capacity after storage/discharge capacity before storage)×100 was calculated. The charge and discharge conditions are similar to those in the case of examining the cycle characteristics.

TABLE 1
Anode active material: artificial graphite

| | | | Cyano cyclic | | | |
|---|---|---|---|---|---|---|
| | Electro- | | ester carbonate | | Cycle | Storage |
| | lyte | | | Content | retention | retention |
| Example | salt | Solvent | Type | (wt %) | ratio (%) | ratio (%) |
| 1-1 | LiPF₆ | EC + | Formula | 0.01 | 70 | 81 |
| 1-2 | | DMC | (1-1) | 0.1 | 75 | 82 |
| 1-3 | | | | 0.5 | 80 | 84 |
| 1-4 | | | | 1 | 82 | 84 |
| 1-5 | | | | 2 | 82 | 84 |
| 1-6 | | | | 5 | 84 | 84 |
| 1-7 | | | | 10 | 83 | 82 |
| 1-8 | | | | 20 | 82 | 81 |
| 1-9 | | | Formula | 2 | 88 | 84 |
| | | | (1-2) | | | |
| 1-10 | | | Formula | 2 | 88 | 84 |
| | | | (1-24) | | | |
| 1-11 | LiPF₆ | EC + | — | — | 65 | 81 |
| 1-12 | | DMC | Formula | 2 | 65 | 80 |
| | | | (18) | | | |

In the case where the carbon material (artificial graphite) was used as an anode active material, if the electrolytic solution contained the cyano cyclic ester carbonate, a high cycle retention ratio and a high storage retention ratio were obtained.

More specifically, the results of the case in which the cyano cyclic ester carbonate or the like was not used (Example 1-11) were regarded as the reference. In the case where the compound not satisfying the conditions shown in Formula (1) was used (Example 1-12), the cycle retention ratio was equal to that of the foregoing reference, while the storage retention ratio was lower than that of the foregoing reference. Meanwhile, in the case where the compounds satisfying the conditions shown in Formula (1) (cyano cyclic ester carbonate) were used (Examples 1-1 to 1-10), the cycle retention ratios and the storage retention ratios were significantly higher than those of the foregoing reference. The foregoing results show the following. That is, in the case where an electrolytic solution contains the cyano cyclic ester carbonate, a decomposition reaction of the electrolytic solution is suppressed specifically even in a high temperature severe conditions.

In particular, in the case where the cyano cyclic ester carbonate was used, if the content thereof in the electrolytic solution was from 0.01 wt % to 20 wt % both inclusive, higher cycle retention ratios and higher storage retention ratios were obtained.

### Examples 2-1 to 2-18

Secondary batteries were fabricated by a procedure similar to that of Example 1-5, except that the composition of the solvent was changed as illustrated in Table 2, and the respective characteristics were examined.

In this case, the following solvents were used in combination with EC. That is, diethyl carbonate (DEC), ethylmethyl carbonate (EMC), and propyl carbonate (PC) were used. In addition, as an unsaturated cyclic ester carbonate, vinylene carbonate (VC) was used. As a halogenated cyclic ester carbonate, 4-fluoro-1,3-dioxolane-2-one (FEC) or trans-4,5-difluoro-1,3-dioxolane-2-one (t-DFEC) was used. As a halogenated chain ester carbonate, bis(fluoromethyl)carbonate (DFDMC) was used. As sultone, propene sultone (PRS) was used. As an acid anhydride, succinic anhydride (SCAH) or sulfopropionic anhydride (PSAH) was used.

The composition of the solvent was EC:PC:DMC=10:20:70 at a weight ratio. The content of VC in the solvent was 2 wt %, the content of FEC, t-DFEC, or DFDMC in the solvent was 5 wt %, and the content of PRS, SCAH, or PSAH in the solvent was 1 wt %.

TABLE 2
Anode active material: artificial graphite

| | | | | Cyano cyclic | | | |
|---|---|---|---|---|---|---|---|
| | | | | ester carbonate | | Cycle | Storage |
| | Electrolyte | | | | Content | retention | retention |
| Example | salt | Solvent | | Type | (wt %) | ratio (%) | ratio (%) |
| 2-1 | LiPF₆ | EC + DEC | | Formula | 2 | 78 | 85 |
| 2-2 | | EC + EMC | | (1-1) | | 80 | 85 |
| 2-3 | | EC + PC + DMC | | | | 81 | 86 |
| 2-4 | | EC + DMC | VC | | | 85 | 89 |
| 2-5 | | | FEC | | | 85 | 90 |
| 2-6 | | | t-DFEC | | | 84 | 88 |
| 2-7 | | | DFDMC | | | 85 | 89 |
| 2-8 | | | PRS | | | 90 | 93 |
| 2-9 | | | SCAH | | | 89 | 92 |
| 2-10 | | | PSAH | | | 92 | 94 |
| 2-11 | | | FEC + VC | | | 91 | 94 |
| 2-12 | | | FEC + PRS | | | 92 | 94 |
| 2-13 | | | FEC + SCAH | | | 93 | 93 |
| 2-14 | | | FEC + PSAH | | | 93 | 95 |
| 2-15 | LiPF₆ | EC + DMC | VC | — | — | 80 | 84 |
| 2-16 | | | FEC | | | 79 | 81 |
| 2-17 | | | t-DFEC | | | 79 | 80 |
| 2-18 | | | DFDMC | | | 78 | 81 |

Even if the composition of the solvent was changed, a high cycle retention ratio and a high storage retention ratio were obtained. In particular, in the case where the electrolytic solution contained the unsaturated cyclic ester carbonate, the halogenated ester carbonate, the sultone, or the acid anhydride, one or both of the cycle retention ratio and the storage retention ratio were more increased.

### Examples 3-1 to 3-17

Secondary batteries were fabricated by a procedure similar to that of Example 1-5 except that an auxiliary compound was added to the electrolytic solution as illustrated in Table 3, and the characteristics were examined.

TABLE 3
Anode active material: artificial graphite

| | | | | Cyano cyclic | | Auxiliary | | | |
|---|---|---|---|---|---|---|---|---|---|
| | | | | ester carbonate | | compound | | Cycle | Storage |
| | Electrolyte | | | | Content | | Content | retention | retention |
| Example | salt | Solvent | | Type | (wt %) | Type | (wt %) | ratio (%) | ratio (%) |
| 3-1 | LiPF₆ | EC + DMC | | Formula | 2 | LiPF₂O₂ | 0.001 | 84 | 88 |
| 3-2 | | | | (1-1) | | | 0.1 | 85 | 89 |
| 3-3 | | | | | | | 0.2 | 85 | 90 |
| 3-4 | | | | | | | 1 | 84 | 88 |
| 3-5 | | | | | | | 2 | 83 | 88 |
| 3-6 | | | | | | Formula | 0.2 | 84 | 89 |
| | | | | | | (2-1) | | | |
| 3-7 | | | | | | Formula | 0.2 | 83 | 88 |
| | | | | | | (3-1) | | | |
| 3-8 | | | | | | Formula | 0.2 | 85 | 90 |
| | | | | | | (4-1) | | | |
| 3-9 | | | | | | Li₂PFO₃ | 0.2 | 84 | 90 |
| 3-10 | LiPF₆ | EC + DMC | FEC | Formula | 2 | LiPF₂O₂ | 0.2 | 88 | 90 |
| 3-11 | | | t-DFEC | (1-1) | | | | 88 | 90 |
| 3-12 | | | DFDMC | | | | | 87 | 88 |

| | | | | | | | | |
|---|---|---|---|---|---|---|---|---|
| 3-13 | LiPF₆ | EC + DMC | — | — | Formula | 0.2 | 77 | 82 |
| | | | | | (2-1) | | | |
| 3-14 | | | | | Formula | 0.2 | 76 | 82 |
| | | | | | (3-1) | | | |
| 3-15 | | | | | Formula | 0.2 | 78 | 81 |
| | | | | | (4-1) | | | |
| 3-16 | | | | | Li₂PFO₃ | 0.2 | 77 | 82 |
| 3-17 | | | | | LiPF₂O₂ | 0.2 | 78 | 82 |

In the case where the electrolytic solution contained the auxiliary compound together with the cyano cyclic ester carbonate, the cycle retention ratio and the storage retention ratio were more increased.

### Examples 4-1 to 4-3

Secondary batteries were fabricated by a procedure similar to that of Example 1-5 except that the composition of the electrolyte salt was changed as illustrated in Table 4, and the respective characteristics were examined.

In this case, as an electrolyte salt combined with LiPF6, lithium tetrafluoroborate (LiBF4), lithium bis[oxalato-O,O′] borate (LiBOB) represented by Formula (12-6), or lithium bis(trifluoromethanesulfonyl)imide (LiN(CF3SO2)2: LiTFSI) was used. In this case, the content of LiPF6 was 0.9 mol/kg with respect to the nonaqueous solvent, and the content of LiBF4 or the like was 0.1 mol/kg with respect to the nonaqueous solvent.

TABLE 4

| | | | | Cyano cyclic | | | |
|---|---|---|---|---|---|---|---|
| | | | | ester carbonate | | Cycle | Storage |
| | | | | | Content | retention | retention |
| Example | Electrolyte salt | | Solvent | Type | (wt %) | ratio (%) | ratio (%) |
| 4-1 | LiPF₆ | LiBF₄ | EC + DMC | Formula | 2 | 80 | 92 |
| 4-2 | | LiTFOB | | (1-1) | | 82 | 93 |
| 4-3 | | LiTFSI | | | | 82 | 92 |

Even if the composition of the electrolyte salt was changed, a high cycle retention ratio and a high storage retention ratio were obtained. In particular, in the case where the electrolytic solution contained other electrolyte salt such as LiBF4, the storage retention ratios were more increased.

### Examples 5-1 to 5-12, 6-1 to 6-18, 7-1 to 7-18, and 8-1 to 8-3

Secondary batteries were fabricated by procedures similar to those of Examples 1-1 to 1-12, 2-1 to 2-18, 3-1 to 3-17, and 4-1 to 4-3 except that a metal-based material (silicon) was used as an anode active material as illustrated in Table 5 to Table 8, and the respective characteristics were examined.

In forming the anode 22, silicon was deposited on both surfaces of the anode current collector 22A by using an electron beam evaporation method, and thereby the anode active material layer 22B was formed. In this case, a deposition step was repeated for 10 times so that the thickness of the anode active material layer 22B became 6 μm.

TABLE 5
Anode active material: silicon

| | | | Cyano cyclic | | | |
|---|---|---|---|---|---|---|
| | Electro- | | ester carbonate | | Cycle | Storage |
| | lyte | | | Content | retention | retention |
| Example | salt | Solvent | Type | (wt %) | ratio (%) | ratio (%) |
| 5-1 | LiPF₆ | EC + | Formula | 0.01 | 42 | 82 |
| 5-2 | | DMC | (1-1) | 0.1 | 43 | 83 |
| 5-3 | | | | 0.5 | 48 | 83 |
| 5-4 | | | | 1 | 50 | 84 |
| 5-5 | | | | 2 | 55 | 85 |
| 5-6 | | | | 5 | 75 | 85 |
| 5-7 | | | | 10 | 75 | 84 |
| 5-8 | | | | 20 | 70 | 82 |
| 5-9 | | | Formula | 5 | 80 | 87 |
| | | | (1-2) | | | |
| 5-10 | | | Formula | 5 | 83 | 87 |
| | | | (1-24) | | | |
| 5-11 | LiPF₆ | EC + | — | — | 40 | 81 |
| 5-12 | | DMC | Formula | 5 | 40 | 80 |
| | | | (1-18) | | | |

TABLE 6
Anode active material: silicon

| | | | | Cyano cyclic | | | |
|---|---|---|---|---|---|---|---|
| | | | | ester carbonate | | Cycle | Storage |
| | Electrolyte | | | | Content | retention | retention |
| Example | salt | Solvent | | Type | (wt %) | ratio (%) | ratio (%) |
| 6-1 | LiPF₆ | EC + DEC | | Formula | 5 | 72 | 88 |
| 6-2 | | EC + EMC | | (1-1) | | 73 | 87 |
| 6-3 | | EC + PC + DMC | | | | 72 | 90 |
| 6-4 | | EC + DMC | VC | | | 82 | 90 |
| 6-5 | | | FEC | | | 80 | 88 |
| 6-6 | | | t-DFEC | | | 85 | 89 |
| 6-7 | | | DFDMC | | | 82 | 88 |
| 6-8 | | | PRS | | | 85 | 92 |
| 6-9 | | | SCAH | | | 85 | 90 |
| 6-10 | | | PSAH | | | 88 | 94 |
| 6-11 | | | FEC + VC | | | 88 | 92 |
| 6-12 | | | FEC + PRS | | | 88 | 94 |
| 6-13 | | | FEC + SCAH | | | 88 | 93 |
| 6-14 | | | FEC + PSAH | | | 90 | 95 |
| 6-15 | LiPF₆ | EC + DMC | VC | — | — | 70 | 84 |
| 6-16 | | | FEC | | | 60 | 81 |
| 6-17 | | | t-DFEC | | | 76 | 78 |
| 6-18 | | | DFDMC | | | 68 | 80 |

TABLE 7
Anode active material: silicon

| | | | | Cyano cyclic | | | | | |
|---|---|---|---|---|---|---|---|---|---|
| | | | | ester carbonate | | Auxiliary compound | | Cycle | Storage |
| | Electrolyte | | | | Content | | Content | retention | retention |
| Example | salt | Solvent | | Type | (wt %) | Type | (wt %) | ratio (%) | ratio (%) |
| 7-1 | LiPF₆ | EC + DMC | | Formula | 5 | LiPF₂O₂ | 0.001 | 72 | 86 |
| 7-2 | | | | (1-1) | | | 0.1 | 74 | 88 |
| 7-3 | | | | | | | 0.2 | 75 | 88 |
| 7-4 | | | | | | | 1 | 75 | 86 |
| 7-5 | | | | | | | 2 | 72 | 85 |
| 7-6 | | | | | | Formula | 0.2 | 74 | 88 |
| | | | | | | (2-1) | | | |
| 7-7 | | | | | | Formula | 0.2 | 75 | 88 |
| | | | | | | (3-1) | | | |
| 7-8 | | | | | | Formula | 0.2 | 72 | 90 |
| | | | | | | (4-1) | | | |
| 7-9 | | | | | | Li₂PFO₃ | 0.2 | 74 | 88 |
| 7-10 | LiPF₆ | EC + DMC | FEC | Formula | 5 | LiPF₂O₂ | 0.2 | 85 | 88 |
| 7-11 | | | t-DFEC | (1-1) | | | | 88 | 89 |
| 7-12 | | | c-DFEC | | | | | 89 | 89 |
| 7-13 | | | DFDMC | | | | | 87 | 88 |

| | | | | | | | | |
|---|---|---|---|---|---|---|---|---|
| 7-14 | LiPF₆ | EC + DMC | — | — | Formula | 0.2 | 42 | 82 |
| | | | | | (2-1) | | | |
| 7-15 | | | | | Formula | 0.2 | 41 | 82 |
| | | | | | (3-1) | | | |
| 7-16 | | | | | Formula | 0.2 | 44 | 83 |
| | | | | | (4-1) | | | |
| 7-17 | | | | | Li₂PFO₃ | 0.2 | 40 | 82 |
| 7-18 | | | | | LiPF₂O₂ | 0.2 | 42 | 82 |

TABLE 8
Anode active material: silicon

| | | | | Cyano cyclic | | | |
|---|---|---|---|---|---|---|---|
| | | | | ester carbonate | | | |
| | | | | | Content | Cycle retention | Storage retention |
| Example | Electrolyte salt | | Solvent | Type | (wt %) | ratio (%) | ratio (%) |
| 8-1 | LiPF₆ | LiBF₄ | EC + DMC | Formula | 5 | 73 | 92 |
| 8-2 | | LiBOB | | (1-1) | | 77 | 92 |
| 8-3 | | LiTFSI | | | | 73 | 92 |

In the case where the metal-based material (silicon) was used as an anode active material, results similar to those in the case of using the carbon material (Table 1 to Table 4) were obtained. That is, in the case where the electrolytic solution contained the cyano cyclic ester carbonate, a high cycle retention ratio and a high storage retention ratio were obtained. Since other trends are similar to those in the case of using the carbon material, description thereof will be omitted.

From the results of Table 1 to Table 8, it was confirmed that in the case where the electrolytic solution contained the cyano cyclic ester carbonate, superior battery characteristics were obtained.

The present technology has been described with reference to the embodiment and Examples. However, the present technology is not limited to the examples described in the embodiment and Examples, and various modifications may be made. For example, the electrolytic solution of the present technology may be applied to other usage such as a capacitor.

Further, in the embodiment and Examples, the description has been given of the lithium ion secondary battery or the lithium metal secondary battery as a secondary battery type. However, applicable secondary battery type is not limited thereto. The secondary battery of the present technology is similarly applicable to a secondary battery in which the anode capacity includes a capacity by inserting and extracting lithium ions and a capacity associated with precipitation and dissolution of lithium metal, and the battery capacity is expressed by the sum of these capacities. In this case, an anode material capable of inserting and extracting lithium ions is used as an anode active material, and the chargeable capacity of the anode material is set to a smaller value than the discharge capacity of the cathode.

Further, in the embodiment and Examples, the description has been given with the specific examples of the case in which the battery structure is the cylindrical type or the laminated film type, and with the specific example in which the battery device has the spirally wound structure. However, applicable structures are not limited thereto. The secondary battery of the present technology is similarly applicable to a battery having other battery structure such as a square type battery, a coin type battery, and a button type battery or a battery in which the battery device has other structure such as a laminated structure.

Further, in the embodiment and Examples, the description has been given of the case using lithium as an electrode reactant. However, the electrode reactant is not limited thereto. As an electrode reactant, for example, other Group 1 element such as sodium (Na) and potassium (K), a Group 2 element such as magnesium and calcium, or other light metals such as aluminum may be used. The effect of the present technology may be obtained without depending on the electrode reactant type, and therefore even if the electrode reactant type is changed, a similar effect is obtainable.

Further, in the embodiment and Examples, for the content of the cyano cyclic ester carbonate, the description has been given of the appropriate range derived from the results of Examples. However, the description does not totally deny a possibility that the content is out of the foregoing range. That is, the foregoing appropriate range is the range particularly preferable for obtaining the effects of the present technology. Therefore, as long as the effects of the present technology are obtained, the content may be out of the foregoing range in some degrees. The same is applied to the contents of the auxiliary compound and the unsaturated cyclic ester carbonate.

It is possible to achieve at least the following configurations from the above-described exemplary embodiment of the disclosure.

(1) A secondary battery including:
a cathode;
an anode; and
an electrolytic solution, wherein
the electrolytic solution includes a cyano cyclic ester carbonate represented by Formula (1) described below,

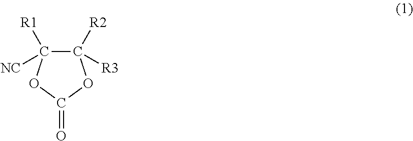

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(2) The secondary battery according to (1), wherein, among the R1 to the R3, the halogen group is one of a fluorine group, a chlorine group, a bromine group, and an iodine group,
each of the monovalent hydrocarbon group and the monovalent halogenated hydrocarbon group is one of an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and a group obtained by substituting part or all of hydrogen groups of each of the foregoing groups with a halogen group, and
each of the monovalent oxygen-containing hydrocarbon group and the monovalent halogenated oxygen-containing hydrocarbon group is one of an alkoxy group with carbon number from 1 to 12 both inclusive and a group obtained by substituting part or all of hydrogen groups thereof with a halogen group.
   (3) The secondary battery according to (1) or (2), wherein the cyano cyclic ester carbonate is one or more of compounds represented by Formula (1-1) to Formula (1-24) described below.

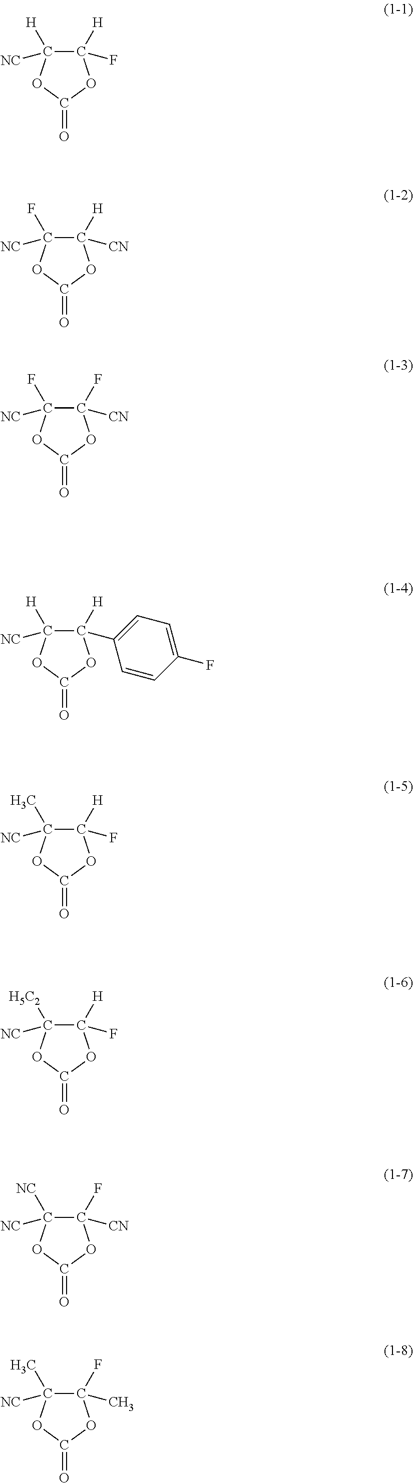

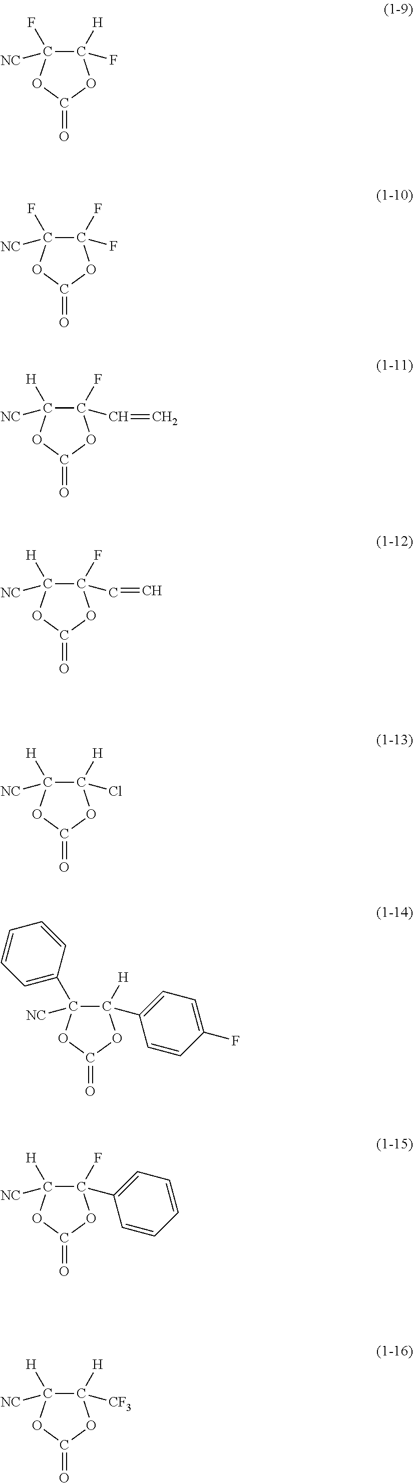

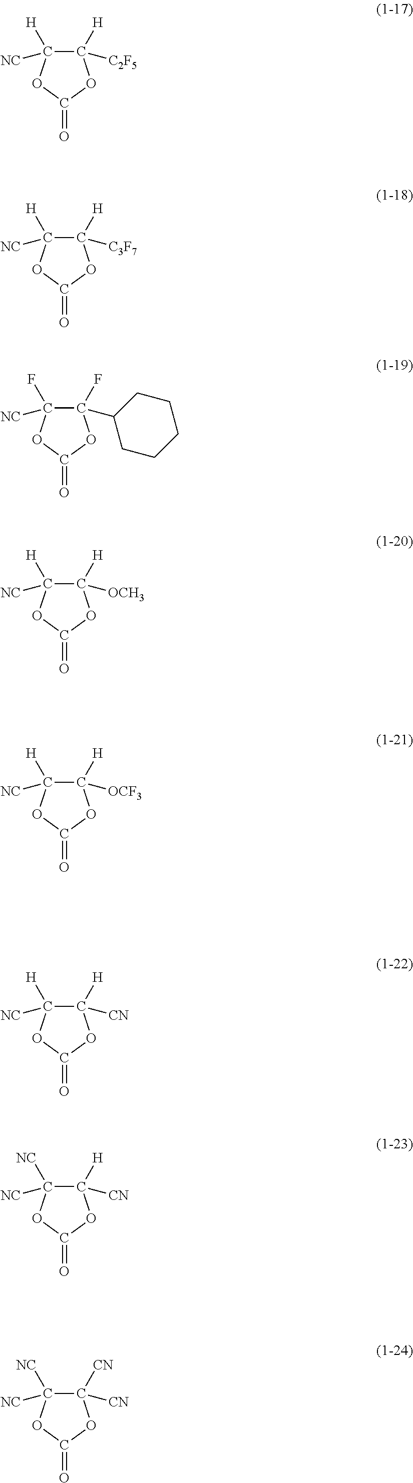

(4) The secondary battery according to any one of (1) to (3), wherein a content of the cyano cyclic ester carbonate in the electrolytic solution is from about 0.01 weight percent to about 20 weight percent both inclusive.
(5) The secondary battery according to any one of (1) to (4), wherein the electrolytic solution includes one or more of compounds represented by Formula (2) to Formula (6) described below,

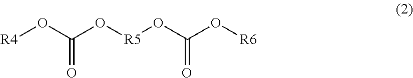

where each of R4 and R6 is one of a monovalent hydrocarbon group, a monovalent halogenated hydrocarbon group, a monovalent oxygen-containing hydrocarbon group, and a monovalent halogenated oxygen-containing hydrocarbon group; and R5 is one of a divalent hydrocarbon group, a divalent halogenated hydrocarbon group, a divalent oxygen-containing hydrocarbon group, and a divalent halogenated oxygen-containing hydrocarbon group,

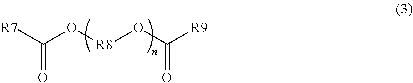

where each of R7 and R9 is one of a monovalent hydrocarbon group, a monovalent halogenated hydrocarbon group, a monovalent oxygen-containing hydrocarbon group, and a monovalent halogenated oxygen-containing hydrocarbon group; R8 is one of a divalent hydrocarbon group, a divalent halogenated hydrocarbon group, a divalent oxygen-containing hydrocarbon group, and a divalent halogenated oxygen-containing hydrocarbon group; and n is an integer number equal to or greater than 1,

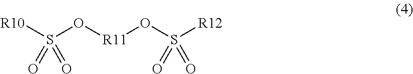

where each of R10 and R12 is one of a monovalent hydrocarbon group, a monovalent halogenated hydrocarbon group, a monovalent oxygen-containing hydrocarbon group, and a monovalent halogenated oxygen-containing hydrocarbon group; and R11 is one of a divalent hydrocarbon group, a divalent halogenated hydrocarbon group, a divalent oxygen-containing hydrocarbon group, and a divalent halogenated oxygen-containing hydrocarbon group,

Li2PFO3 (5)

LiPF2O2 (6).

(6) The secondary battery according to (5), wherein, among the R4 to the R12, each of the monovalent hydrocarbon group and the monovalent halogenated hydrocarbon group is one of an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and a group obtained by substituting part or all of hydrogen groups of each of the foregoing groups with a halogen group,
each of the monovalent oxygen-containing hydrocarbon group and the monovalent halogenated oxygen-containing hydrocarbon group is one of an alkoxy group with carbon number from 1 to 12 both inclusive and a group obtained by substituting part or all of hydrogen groups thereof with a halogen group,
each of the divalent hydrocarbon group and the divalent halogenated hydrocarbon group is one of an alkylene group with carbon number from 1 to 12 both inclusive, an alkenylene group with carbon number from 2 to 12 both inclusive, an alkynylene group with carbon number from 2 to 12 both inclusive, an arylene group with carbon number from 6 to 18 both inclusive, a cycloalkylene group with carbon number from 3 to 18 both inclusive, a group including an arylene group and an alkylene group, and a group obtained by substituting part or all of hydrogen groups of each of the foregoing groups with a halogen group, and
each of the divalent oxygen-containing hydrocarbon group and the divalent halogenated oxygen-containing hydrocarbon group is one of a group including an ether bond and an alkylene group, and a group obtained by substituting part or all of hydrogen groups thereof by a halogen group.
   (7) The secondary battery according to (5) or (6), wherein the compound represented by the Formula (2) is one of compounds represented by Formula (2-1) to Formula (2-12) described below,
the compound represented by the Formula (3) is one of compounds represented by Formula (3-1) to Formula (3-17) described below, and
the compound represented by the Formula (4) is one of compounds represented by Formula (4-1) to Formula (4-9) described below,

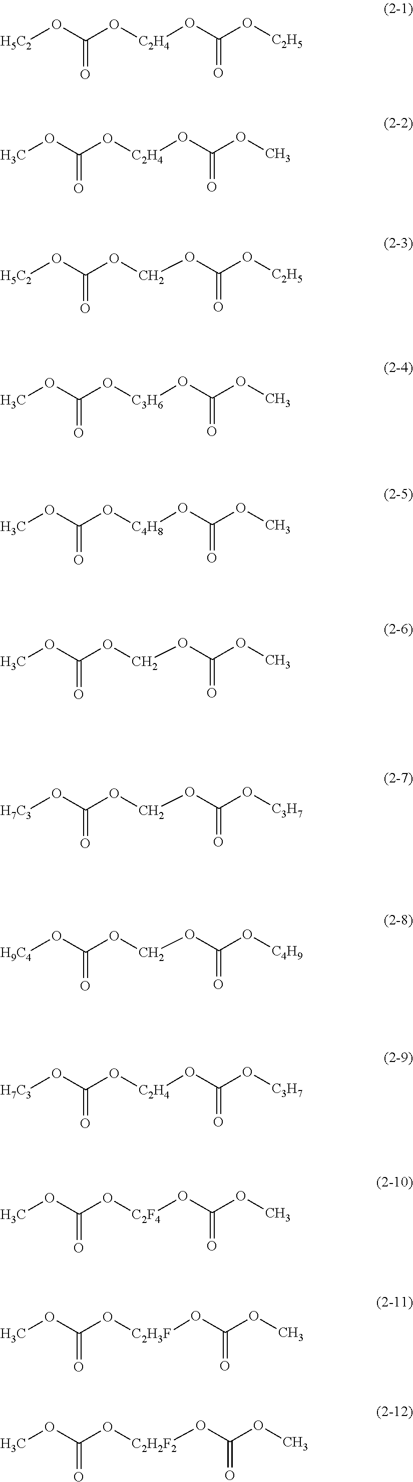

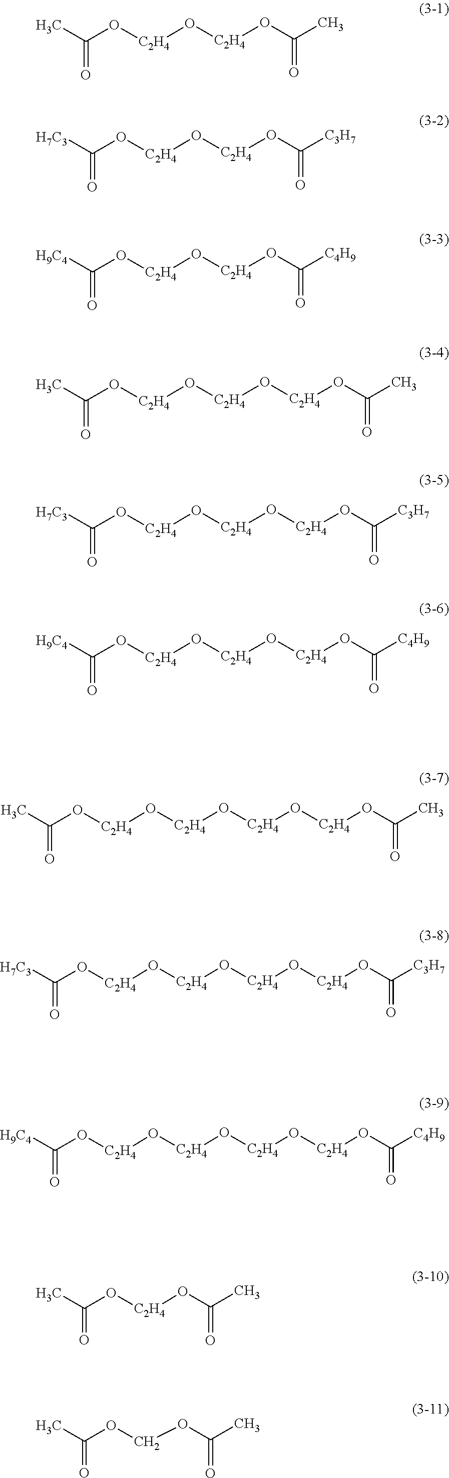

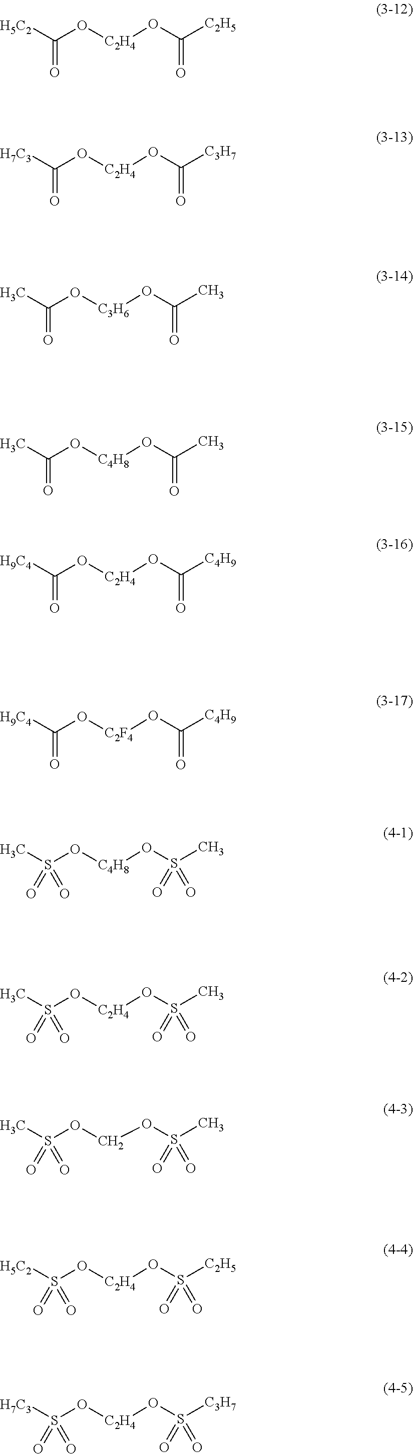

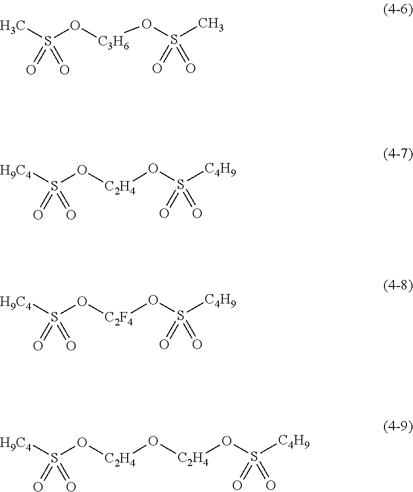

(8) The secondary battery according to any one of (5) to (7), wherein a content of the compounds represented by the Formula (2) to the Formula (6) in the electrolytic solution is from about 0.001 weight percent to about 2 weight percent both inclusive.
(9) The secondary battery according to any one of (1) to (8), wherein the secondary battery is a lithium ion secondary battery.
(10) An electrolytic solution including a cyano cyclic ester carbonate represented by Formula (1) described below,

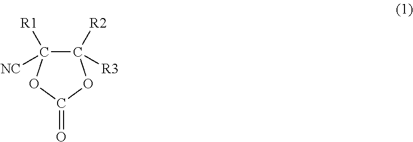

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(11) A battery pack including:
a secondary battery;
a control section controlling a usage state of the secondary battery; and
a switch section switching the usage state of the secondary battery according to an instruction of the control section,
wherein
the secondary battery includes a cathode, an anode, and an electrolytic solution, and
the electrolytic solution includes a cyano cyclic ester carbonate represented by Formula (1) described below,

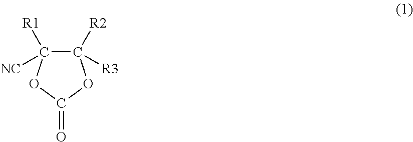

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(12) An electric vehicle including:
a secondary battery;
a conversion section converting electric power supplied from the secondary battery to drive power;
a drive section operating according to the drive power; and
a control section controlling a usage state of the secondary battery,
wherein
the secondary battery includes a cathode, an anode, and an electrolytic solution, and
the electrolytic solution includes a cyano cyclic ester carbonate represented by Formula (1) described below,

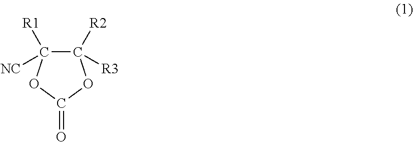

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(13) An electric power storage system including:
a secondary battery;
one, or two or more electric devices supplied with electric power from the secondary battery; and
a control section controlling the supply of the electric power from the secondary battery to the electric device,
wherein
the secondary battery includes a cathode, an anode, and an electrolytic solution, and
the electrolytic solution includes a cyano cyclic ester carbonate represented by Formula (1) described below,

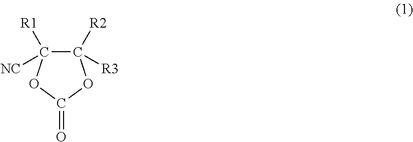

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(14) An electric power tool including:
a secondary battery; and
a movable section being supplied with electric power from the secondary battery, wherein
the secondary battery includes a cathode, an anode, and an electrolytic solution, and
the electrolytic solution includes a cyano cyclic ester carbonate represented by Formula (1) described below,

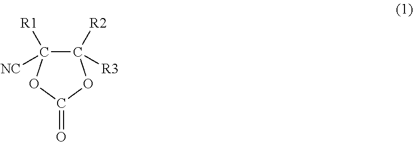

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
(15) An electronic device including a secondary battery as an electric power supply source,
wherein
the secondary battery includes a cathode, an anode, and an electrolytic solution, and
the electrolytic solution includes a cyano cyclic ester carbonate represented by Formula (1) described below,

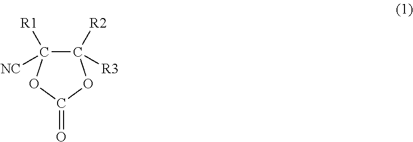

where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. A secondary battery comprising:
a cathode;
an anode; and
an electrolytic solution, wherein
the electrolytic solution includes a cyano cyclic ester carbonate represented by Formula (1) described below, 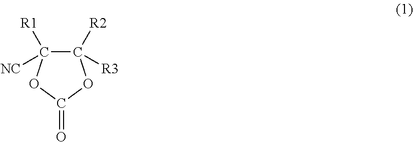
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

2. The secondary battery according to claim 1, wherein, among the R1 to the R3, the halogen group is one of a fluorine group, a chlorine group, a bromine group, and an iodine group,
each of the monovalent hydrocarbon group and the monovalent halogenated hydrocarbon group is one of an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and a group obtained by substituting part or all of hydrogen groups of each of the foregoing groups with a halogen group, and
each of the monovalent oxygen-containing hydrocarbon group and the monovalent halogenated oxygen-containing hydrocarbon group is one of an alkoxy group with carbon number from 1 to 12 both inclusive and a group obtained by substituting part or all of hydrogen groups thereof with a halogen group.

3. The secondary battery according to claim 1, wherein the cyano cyclic ester carbonate is one or more of compounds represented by Formula (1-1) to Formula (1-24) described below.

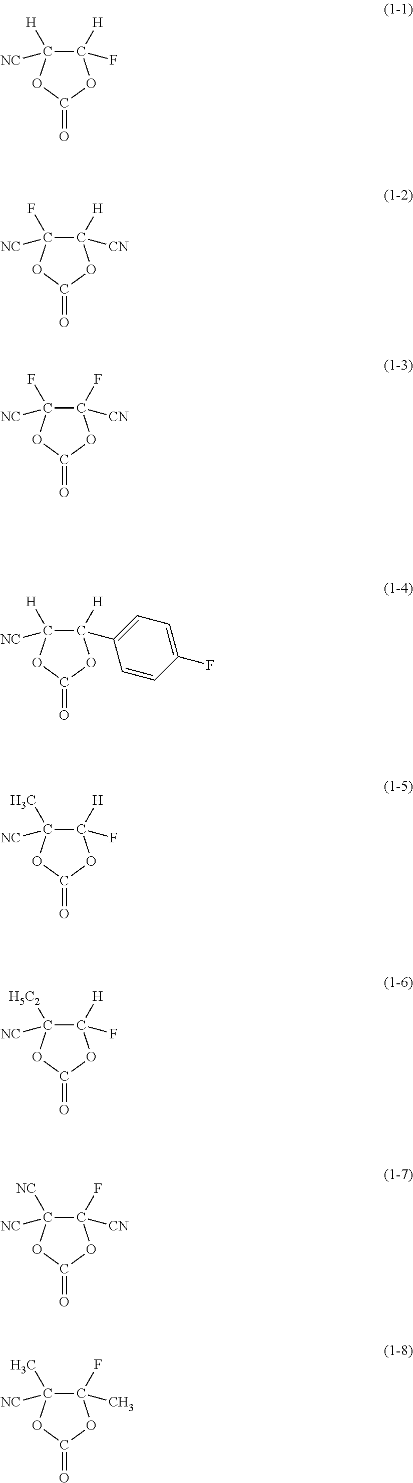

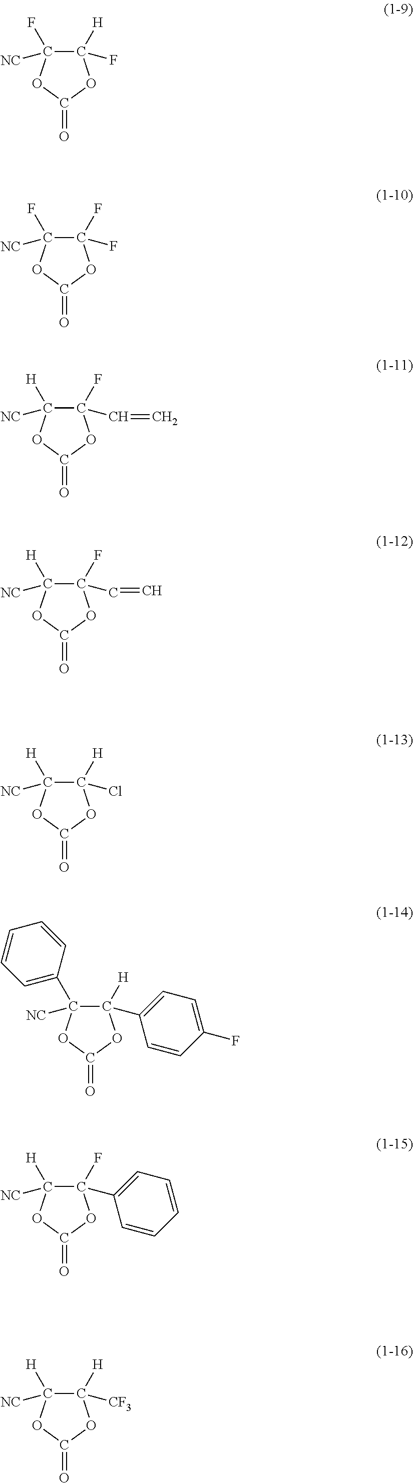

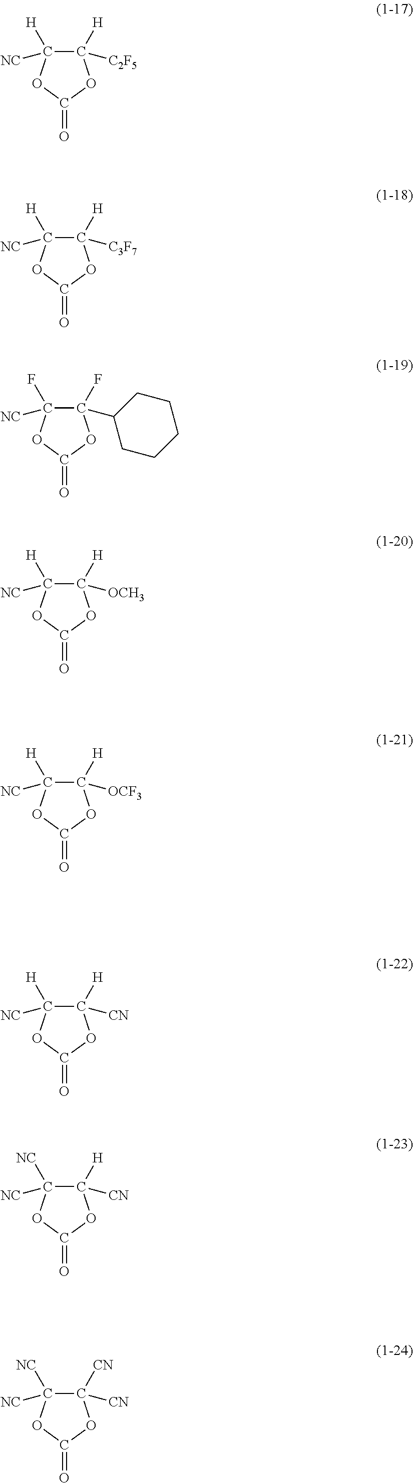

4. The secondary battery according to claim 1, wherein a content of the cyano cyclic ester carbonate in the electrolytic solution is from about 0.01 weight percent to about 20 weight percent both inclusive.

5. The secondary battery according to claim 1, wherein the electrolytic solution includes one or more of compounds represented by Formula (2) to Formula (6) described below, 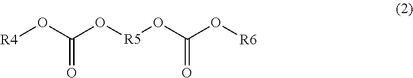
where each of R4 and R6 is one of a monovalent hydrocarbon group, a monovalent halogenated hydrocarbon group, a monovalent oxygen-containing hydrocarbon group, and a monovalent halogenated oxygen-containing hydrocarbon group; and R5 is one of a divalent hydrocarbon group, a divalent halogenated hydrocarbon group, a divalent oxygen-containing hydrocarbon group, and a divalent halogenated oxygen-containing hydrocarbon group, 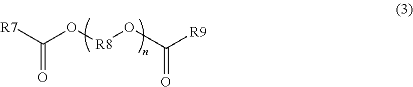
where each of R7 and R9 is one of a monovalent hydrocarbon group, a monovalent halogenated hydrocarbon group, a monovalent oxygen-containing hydrocarbon group, and a monovalent halogenated oxygen-containing hydrocarbon group; R8 is one of a divalent hydrocarbon group, a divalent halogenated hydrocarbon group, a divalent oxygen-containing hydrocarbon group, and a divalent halogenated oxygen-containing hydrocarbon group; and n is an integer number equal to or greater than 1, 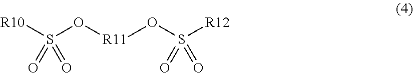
where each of R10 and R12 is one of a monovalent hydrocarbon group, a monovalent halogenated hydrocarbon group, a monovalent oxygen-containing hydrocarbon group, and a monovalent halogenated oxygen-containing hydrocarbon group; and R11 is one of a divalent hydrocarbon group, a divalent halogenated hydrocarbon group, a divalent oxygen-containing hydrocarbon group, and a divalent halogenated oxygen-containing hydrocarbon group,
Li2PFO3 (5)
LiPF2O2 (6).

6. The secondary battery according to claim 5, wherein, among the R4 to the R12, each of the monovalent hydrocarbon group and the monovalent halogenated hydrocarbon group is one of an alkyl group with carbon number from 1 to 12 both inclusive, an alkenyl group with carbon number from 2 to 12 both inclusive, an alkynyl group with carbon number from 2 to 12 both inclusive, an aryl group with carbon number from 6 to 18 both inclusive, a cycloalkyl group with carbon number from 3 to 18 both inclusive, and a group obtained by substituting part or all of hydrogen groups of each of the foregoing groups with a halogen group,
each of the monovalent oxygen-containing hydrocarbon group and the monovalent halogenated oxygen-containing hydrocarbon group is one of an alkoxy group with carbon number from 1 to 12 both inclusive and a group obtained by substituting part or all of hydrogen groups thereof with a halogen group,
each of the divalent hydrocarbon group and the divalent halogenated hydrocarbon group is one of an alkylene group with carbon number from 1 to 12 both inclusive, an alkenylene group with carbon number from 2 to 12 both inclusive, an alkynylene group with carbon number from 2 to 12 both inclusive, an arylene group with carbon number from 6 to 18 both inclusive, a cycloalkylene group with carbon number from 3 to 18 both inclusive, a group including an arylene group and an alkylene group, and a group obtained by substituting part or all of hydrogen groups of each of the foregoing groups with a halogen group, and
each of the divalent oxygen-containing hydrocarbon group and the divalent halogenated oxygen-containing hydrocarbon group is one of a group including an ether bond and an alkylene group, and a group obtained by substituting part or all of hydrogen groups thereof by a halogen group.

7. The secondary battery according to claim 5, wherein the compound represented by the Formula (2) is one of compounds represented by Formula (2-1) to Formula (2-12) described below,
the compound represented by the Formula (3) is one of compounds represented by Formula (3-1) to Formula (3-17) described below, and
the compound represented by the Formula (4) is one of compounds represented by Formula (4-1) to Formula (4-9) described below,

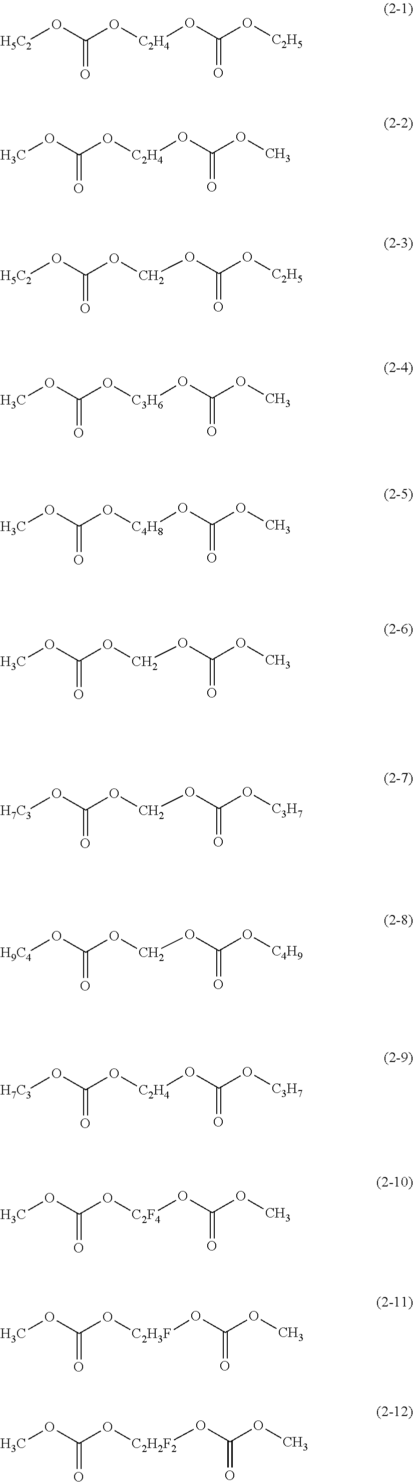

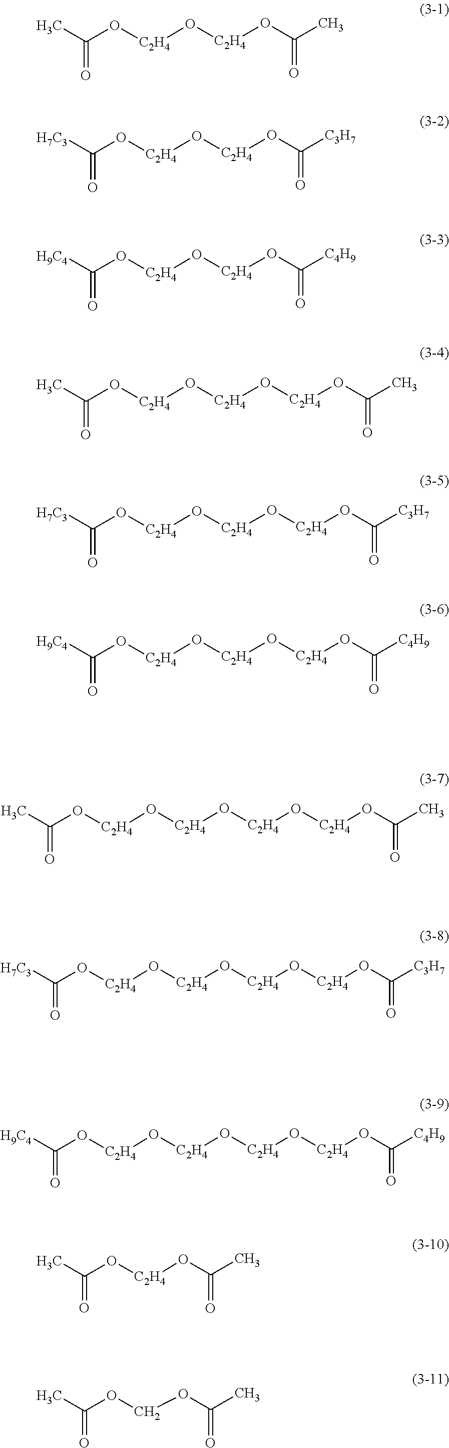

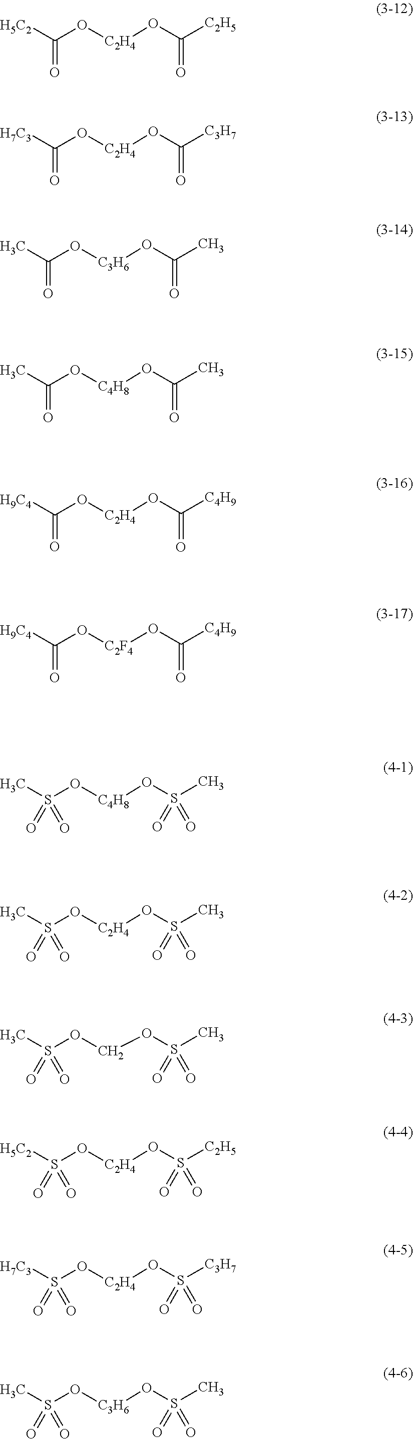

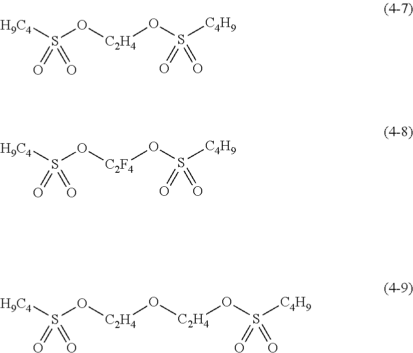

8. The secondary battery according to claim 5, wherein a content of the compounds represented by the Formula (2) to the Formula (6) in the electrolytic solution is from about 0.001 weight percent to about 2 weight percent both inclusive.

9. The secondary battery according to claim 1, wherein the secondary battery is a lithium ion secondary battery.

10. An electrolytic solution including a cyano cyclic ester carbonate represented by Formula (1) described below, 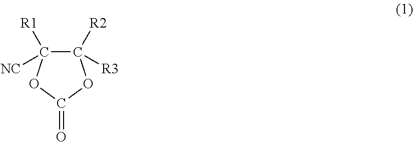
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

11. A battery pack comprising:
a secondary battery;
a control section controlling a usage state of the secondary battery; and
a switch section switching the usage state of the secondary battery according to an instruction of the control section,
wherein
the secondary battery includes a cathode, an anode, and an electrolytic solution, and
the electrolytic solution includes a cyano cyclic ester carbonate represented by Formula (1) described below, 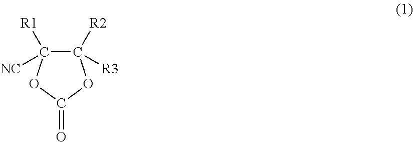
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

12. An electric vehicle comprising:
a secondary battery;
a conversion section converting electric power supplied from the secondary battery to drive power;
a drive section operating according to the drive power; and
a control section controlling a usage state of the secondary battery,
wherein
the secondary battery includes a cathode, an anode, and an electrolytic solution, and
the electrolytic solution includes a cyano cyclic ester carbonate represented by Formula (1) described below, 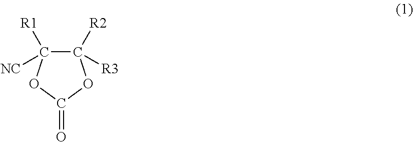
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

13. An electric power storage system comprising:
a secondary battery;
one, or two or more electric devices supplied with electric power from the secondary battery; and
a control section controlling the supply of the electric power from the secondary battery to the electric device,
wherein
the secondary battery includes a cathode, an anode, and an electrolytic solution, and
the electrolytic solution includes a cyano cyclic ester carbonate represented by Formula (1) described below, 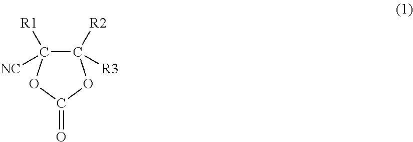
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

14. An electric power tool comprising:
a secondary battery; and
a movable section being supplied with electric power from the secondary battery, wherein
the secondary battery includes a cathode, an anode, and an electrolytic solution, and
the electrolytic solution includes a cyano cyclic ester carbonate represented by Formula (1) described below, 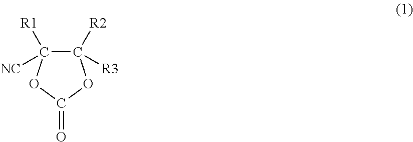
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.

15. An electronic device comprising a secondary battery as an electric power supply source,
wherein
the secondary battery includes a cathode, an anode, and an electrolytic solution, and
the electrolytic solution includes a cyano cyclic ester carbonate represented by Formula (1) described below, 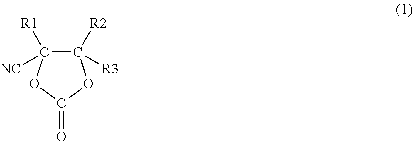
where each of R1 to R3 is one of a hydrogen group, a halogen group, a cyano group, a monovalent hydrocarbon group, a monovalent halogenated hydrocarbon group, a monovalent oxygen-containing hydrocarbon group, and a monovalent halogenated oxygen-containing hydrocarbon group; arbitrary two or more of the R1 to the R3 are allowed to be bonded to each other; and when the total number of cyano groups is 1, one or more of the R1 to the R3 each are a halogen group, a monovalent halogenated hydrocarbon group, or a monovalent halogenated oxygen-containing hydrocarbon group.
